(19) United States
(12) Patent Application Publication
(10) Pub. No.: US 2026/0312334 A1
(43) Pub. Date: Oct. 8, 2026

(54) CONNECTOR ASSEMBLY AND STRUCTURE

(71) Applicant: Japan Aviation Electronics Industry, Limited, Tokyo (JP)

(72) Inventor: Masahiro YAMADA, Tokyo (JP)

(73) Assignee: Japan Aviation Electronics Industry, Limited, Tokyo (JP)

(21) Appl. No.: 19/541,535

(22) Filed: Feb. 17, 2026

(30) Foreign Application Priority Data
Apr. 3, 2025 (JP) 2025-062115

(51) Int. Cl. H01R 13/627; H01R 13/516; H01R 13/52; H01R 13/6582

(52) U.S. Cl. CPC H01R 13/6272; H01R 13/516; H01R 13/5202; H01R 13/6275; H01R 13/6582

(57) ABSTRACT

A connector assembly is attachable to a case having a first position-regulated portion and a second position-regulated portion. The connector assembly comprises a first connector and a second connector which are mateable with each other. The first connector has a first position-regulating portion. The second connector has a second position-regulating portion. The connector assembly is attachable to the case in a completely mated state where the first connector and the second connector are completely mated with each other. When the connector assembly in the completely mated state is attached to the case, one of the first position-regulating portion and the first position-regulated portion receives a remaining one of the first position-regulating portion and the first position-regulated portion while one of the second position-regulating portion and the second position-regulated portion receives a remaining one of the second position-regulating portion and the second position-regulated portion.

### CROSS REFERENCE TO RELATED APPLICATIONS

This application is based on and claims priority under 35 U.S.C. §119 to Japanese Patent Applications No. JP 2025-062115 filed Apr. 3, 2025, the contents of which are incorporated herein in their entirety by reference.

### BACKGROUND OF THE INVENTION

This invention relates to a connector assembly comprising a first connector and a second connector which are mateable with each other.

JPA 2022-134174 (Patent Document 1) discloses a connector 900, or a connector assembly 900 of this type. As shown in FIG. 49, the connector assembly 900 of Patent Document 1 comprises a mating housing 910, or a first connector 910, a housing 920, or a second connector 920, and a mating detection member 930. The first connector 910 has an engaged portion 912. The second connector 920 has an engaging portion 922. The mating detection member 930 is attached to the second connector 920. The mating detection member 930 has a locking protrusion 932. In a state shown in each of FIGS. 49 and 50, the mating detection member 930 is located at a first position P1. In a state shown in FIG. 51, the mating detection member 930 is located at a second position P2. The second position P2 is located beyond the first position P1 in a positive X-direction of an X-direction.

Referring to FIG. 49, when the first connector 910 and the second connector 920 are in the middle of their mating process, the locking protrusion 932 is located beyond the engaging portion 922 in a negative X-direction of the X-direction and faces the engaging portion 922 in the X-direction. This prevents movement of the mating detection member 930 in the positive X-direction from the first position P1 when the first connector 910 and the second connector 920 are in the middle of their mating process. Referring to FIG. 50, in a completely mated state where the first connector 910 and the second connector 920 are completely mated with each other, the engaging portion 922 faces the engaged portion 912 in the X-direction while the locking protrusion 932 is pressed to be moved in a negative Z-direction by the engaged portion 912 and does not face the engaging portion 922 in the X-direction. Accordingly, the mating detection member 930 is movable from the first position P1 to the second position P2 in the completely mated state. As shown in FIGS. 50 and 51, when the mating detection member 930 is moved from the first position P1 to the second position P2 in the completely mated state, the locking protrusion 932 is moved through an area located in the negative Z-direction beyond the engaging portion 922, and then reaches an area located in the positive X-direction beyond the engaging portion 922. This locks the completely mated state of the first connector 910 and the second connector 920. In other words, the connector assembly 900 of Patent Document 1 has a connector position assurance function, or a CPA function, and the mating detection member 930 functions as a CPA member for assuring the complete mating of the first connector 910 with the second connector 920.

In a connector assembly such as the connector assembly 900 of Patent Document 1, there is a possibility that complete mating of a first connector with a second connector is not assured by, for example, a user forgetting to operate a CPA member.

### SUMMARY OF THE INVENTION

It is therefore an object of the present invention to provide a connector assembly which more reliably assures complete mating of a first connector with a second connector.

One aspect of the present invention provides a connector assembly attachable to a case having a first position-regulated portion and a second position-regulated portion. The connector assembly comprises a first connector and a second connector which are mateable with each other. The first connector has a first position-regulating portion. The second connector has a second position-regulating portion. The connector assembly is attachable to the case in a completely mated state where the first connector and the second connector are completely mated with each other. When the connector assembly in the completely mated state is attached to the case, one of the first position-regulating portion and the first position-regulated portion receives a remaining one of the first position-regulating portion and the first position-regulated portion while one of the second position-regulating portion and the second position-regulated portion receives a remaining one of the second position-regulating portion and the second position-regulated portion.

The connector assembly of the present invention is configured as follows: the connector assembly is attachable to the case in the completely mated state where the first connector and the second connector are completely mated with each other; and, when the connector assembly in the completely mated state is attached to the case, the one of the first position-regulating portion and the first position-regulated portion receives the remaining one of the first position-regulating portion and the first position-regulated portion while the one of the second position-regulating portion and the second position-regulated portion receives the remaining one of the second position-regulating portion and the second position-regulated portion. This prevents the connector assembly of the present invention from being attached to the case in a middle-of-mating state where the first connector and the second connector are not completely mated with each other. In other words, the connector assembly of the present invention more reliably assures the complete mating of the first connector with the second connector.

An appreciation of the objectives of the present invention and a more complete understanding of its structure may be had by studying the following description of the preferred embodiment and by referring to the accompanying drawings.

### BRIEF DESCRIPTION OF THE DRAWINGS

FIG. 1 is a perspective view showing a structure according to a first embodiment of the present invention. In the figure, a first connector and a second connector are in a completely mated state where the first connector and the second connector are completely mated with each other, and a connector assembly is attached to a case.

FIG. 2 is another perspective view showing the structure of FIG. 1.

FIG. 3 is a top view showing the structure of FIG. 1.

FIG. 4 is a cross-sectional view showing the structure of FIG. 3, taken along line A-A. In the figure, parts of the structure are enlarged and illustrated.

FIG. 5 is a side view showing the structure of FIG. 1.

FIG. 6 is a bottom view showing the structure of FIG. 1.

FIG. 7 is a front view showing the structure of FIG. 1.

FIG. 8 is a rear view showing the structure of FIG. 1.

FIG. 9 is still another perspective view showing the structure of FIG. 1. In the figure, the first connector and the second connector are in the completely mated state, while the connector assembly is not attached to the case.

FIG. 10 is a top view showing the structure of FIG. 9.

FIG. 11 is a cross-sectional view showing the structure of FIG. 10, taken along line B-B. In the figure, parts of the structure are enlarged and illustrated.

FIG. 12 is yet another perspective view showing the structure of FIG. 1. In the figure, the first connector and the second connector are in the middle of their mating process, or in a middle-of-mating state, while the connector assembly is not attached to the case.

FIG. 13 is a top view showing the structure of FIG. 12.

FIG. 14 is a cross-sectional view showing the structure of FIG. 13, taken along line C-C. In the figure, parts of the structure are enlarged and illustrated.

FIG. 15 is yet still another perspective view showing the structure of FIG. 1. In the figure, the first connector and the second connector are in an unmated state where the first connector and the second connector are not mated with each other, and the connector assembly is not attached to the case.

FIG. 16 is a perspective view showing the connector assembly which is included in the structure of FIG. 2.

FIG. 17 is a side view showing the first connector which is included in the structure of FIG. 15.

FIG. 18 is a bottom view showing the first connector of FIG. 17.

FIG. 19 is a front view showing the first connector of FIG. 17.

FIG. 20 is a rear view showing the first connector of FIG. 17.

FIG. 21 is a side view showing the second connector which is included in the structure of FIG. 15.

FIG. 22 is a bottom view showing the second connector of FIG. 21.

FIG. 23 is a front view showing the second connector of FIG. 21.

FIG. 24 is a rear view showing the second connector of FIG. 21.

FIG. 25 is a perspective view showing a structure according to a second embodiment of the present invention. In the figure, a first connector and a second connector are in a completely mated state where the first connector and the second connector are completely mated with each other, and a connector assembly is attached to a case. Additionally, in the figure, a part of the structure is enlarged and illustrated.

FIG. 26 is a top view showing the structure of FIG. 25. In the figure, a part of the structure is enlarged and illustrated.

FIG. 27 is a side view showing the structure of FIG. 25. In the figure, a part of the structure is enlarged and illustrated.

FIG. 28 is a bottom view showing the structure of FIG. 25.

FIG. 29 is a front view showing the structure of FIG. 25.

FIG. 30 is a rear view showing the structure of FIG. 25.

FIG. 31 is another perspective view showing the structure of FIG. 25. In the figure, the first connector and the second connector are in the completely mated state, while the connector assembly is not attached to the case. Additionally, in the figure, parts of the structure are enlarged and illustrated.

FIG. 32 is a side view showing the structure of FIG. 31. In the figure, a part of the structure is enlarged and illustrated.

FIG. 33 is another perspective view showing the structure of FIG. 25. In the figure, the first connector and the second connector are in the middle of their mating process, or in a middle-of-mating state, while the connector assembly is not attached to the case. Additionally, in the figure, parts of the structure are enlarged and illustrated.

FIG. 34 is a top view showing the structure of FIG. 33.

FIG. 35 is a cross-sectional view showing the structure of FIG. 34, taken along line D-D. In the figure, parts of the structure are enlarged and illustrated.

FIG. 36 is a perspective view showing the first connector which is included in the structure of FIG. 33.

FIG. 37 is a side view showing the first connector of FIG. 36.

FIG. 38 is a front view showing the first connector of FIG. 36.

FIG. 39 is a rear view showing the first connector of FIG. 36.

FIG. 40 is a perspective view showing the second connector which is included in the structure of FIG. 33.

FIG. 41 is a side view showing the second connector of FIG. 40.

FIG. 42 is a front view showing the second connector of FIG. 40.

FIG. 43 is a rear view showing the second connector of FIG. 40.

FIG. 44 is a top view showing a part of a first modification of the structure of FIG. 26.

FIG. 45 is another top view showing the structure of FIG. 44.

FIG. 46 is a top view showing a part of a second modification of the structure of FIG. 26.

FIG. 47 is another top view showing the structure of FIG. 46.

FIG. 48 is a perspective view showing a third modification of the structure of FIG. 31. In the figure, a first connector and a second connector are in a completely mated state where the first connector and the second connector are completely mated with each other, while a connector assembly is not attached to a case. Additionally, in the figure, a part of the structure is enlarged and illustrated.

FIG. 49 is a cross-sectional view showing a connector described in Patent Document 1. In the figure, a housing and a mating housing are in an unmated state where the housing and the mating housing are not mated with each other, and a mating detection member is located at a first position.

FIG. 50 is another cross-sectional view showing the connector of FIG. 49. In the figure, the housing and the mating housing are in a completely mated state where the housing and the mating housing are completely mated with each other, and the mating detection member is located at the first position.

FIG. 51 is still another cross-sectional view showing the connector of FIG. 49. In the figure, the housing and the mating housing are in the completely mated state, and the mating detection member is located at a second position.

While the invention is susceptible to various modifications and alternative forms, specific embodiments thereof are shown by way of example in the drawings and will herein be described in detail. It should be understood, however, that the drawings and detailed description thereto are not intended to limit the invention to the particular form disclosed, but on the contrary, the intention is to cover all modifications, equivalents and alternatives falling within the spirit and scope of the present invention as defined by the appended claims.

### DETAILED DESCRIPTION

### First embodiment

Referring to FIG. 4, a structure 800 according to a first embodiment of the present invention comprises a case 700 and a connector assembly 10. Specifically, the case 700 has an attached portion 710 with a plate-like shape, and the connector assembly 10 is attachable to the attached portion 710 along a predetermined direction. In the present embodiment, the predetermined direction is a Z-direction. Specifically, it is assumed that a first orientation is a positive Z-direction while a second orientation is a negative Z-direction.

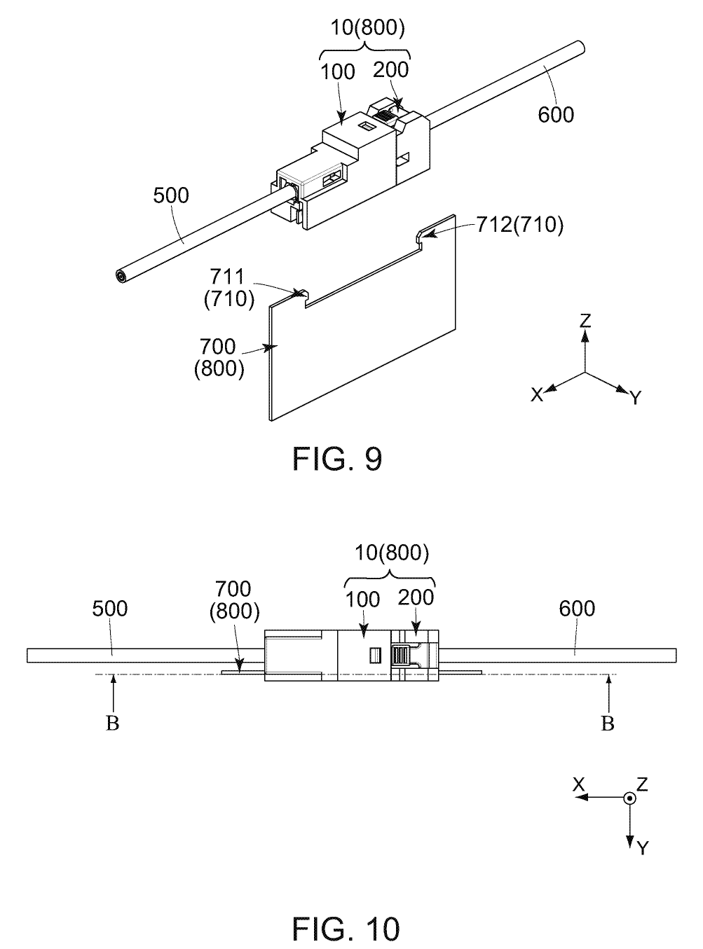

As shown in FIG. 9, the case 700 of the present embodiment is formed from a plate member extending in a plane which is defined by the predetermined direction and a perpendicular direction perpendicular to the predetermined direction. In the present embodiment, the perpendicular direction is an X-direction. Specifically, it is assumed that a third orientation is a positive X-direction while a fourth orientation is a negative X-direction. The case 700 has a first position-regulated portion 711 and a second position-regulated portion 712.

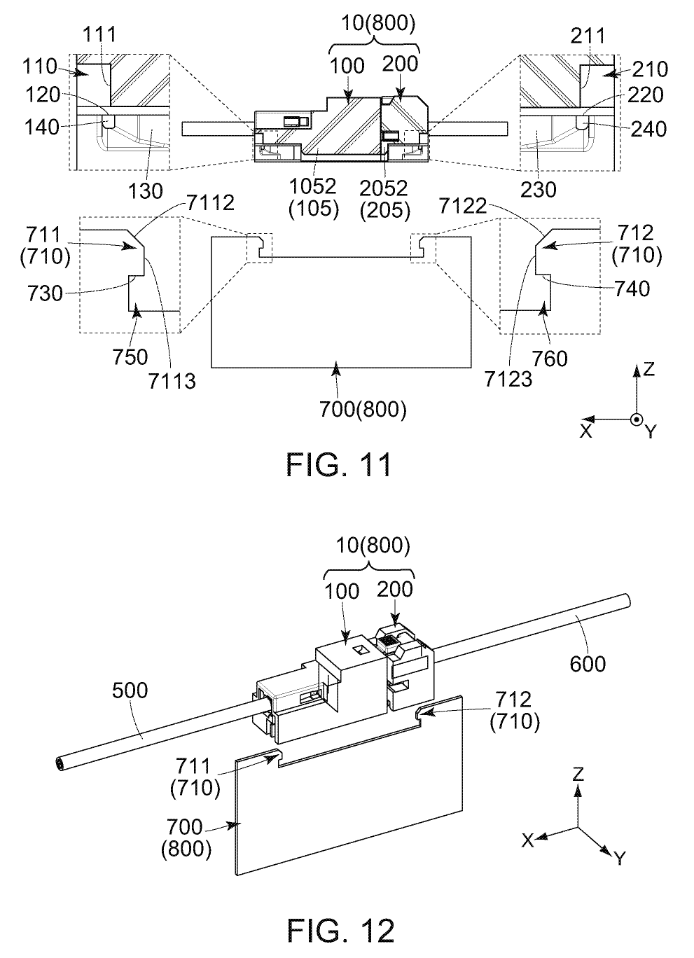

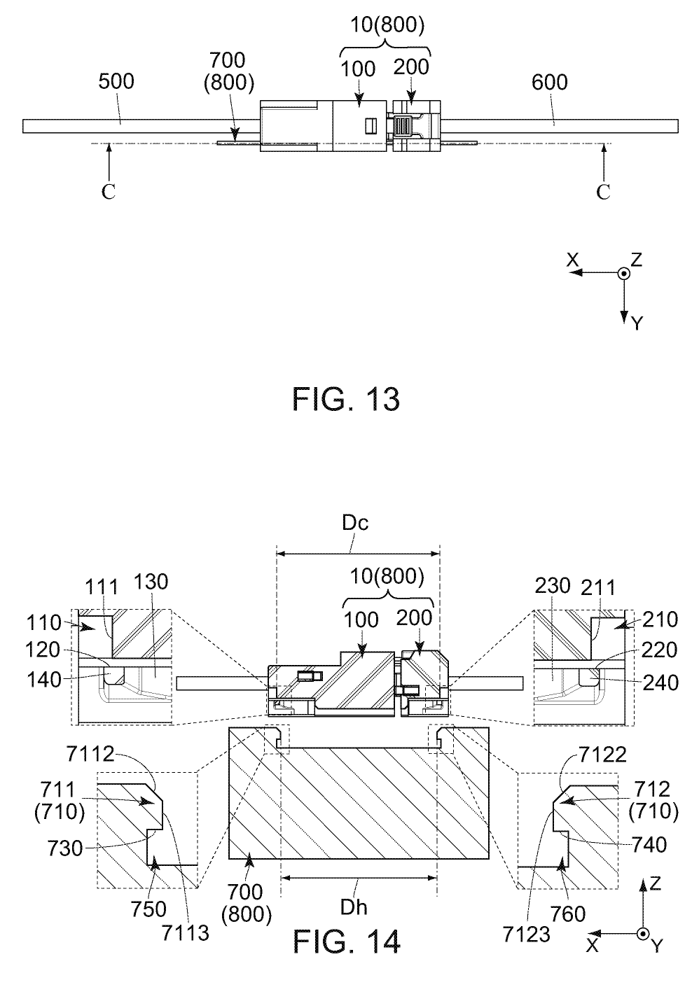

As shown in FIG. 9, the first position-regulated portion 711 of the present embodiment has a flat-plate shape extending in the plane which is perpendicular to a width direction perpendicular to both the predetermined direction and the perpendicular direction. In the present embodiment, the width direction is a Y-direction. Specifically, it is assumed that a fifth orientation is a positive Y-direction while a sixth orientation is a negative Y-direction. As shown in FIG. 11, the first position-regulated portion 711 and the second position-regulated portion 712 are located apart from each other in the perpendicular direction perpendicular to the predetermined direction. The first position-regulated portion 711 is located in the third orientation beyond the second position-regulated portion 712. The first position-regulated portion 711 is formed as a part of the attached portion 710. The first position-regulated portion 711 is provided with a guide portion 7112, or a first guide portion 7112. Specifically, the first guide portion 7112 is oblique to the predetermined direction.

As shown in FIG. 11, the first guide portion 7112 of the present embodiment defines an end of the first position-regulated portion 711 in the first orientation of the predetermined direction. The first guide portion 7112 is oblique to both the predetermined direction and the perpendicular direction.

As shown in FIG. 11, the first position-regulated portion 711 is provided with a first facing portion 7113.

As shown in FIG. 11, the first facing portion 7113 of the present embodiment intersects with the perpendicular direction. The first facing portion 7113 is directed in the fourth orientation. The first facing portion 7113 is located in the second orientation beyond the first guide portion 7112. The first guide portion 7112 extends in the first orientation and the third orientation from the first facing portion 7113.

As shown in FIG. 11, the second position-regulated portion 712 of the present embodiment has a flat-plate shape extending in the plane perpendicular to the width direction. The second position-regulated portion 712 is formed as a part of the attached portion 710. The second position-regulated portion 712 is provided with a guide portion 7122, or a second guide portion 7122. Specifically, the second guide portion 7122 is oblique to the predetermined direction.

As shown in FIG. 11, the second guide portion 7122 of the present embodiment defines an end of the second position-regulated portion 712 in the first orientation of the predetermined direction. The second guide portion 7122 is oblique to both the predetermined direction and the perpendicular direction.

As shown in FIG. 11, the second position-regulated portion 712 is provided with a second facing portion 7123.

As shown in FIG. 11, the second facing portion 7123 of the present embodiment intersects with the perpendicular direction. The second facing portion 7123 is directed in the third orientation. The second facing portion 7123 is located in the second orientation beyond the second guide portion 7122. The second facing portion 7123 is located at the same position as the first facing portion 7113 in the predetermined direction. The second facing portion 7123 is located at the same position as the first facing portion 7113 in the width direction. The second guide portion 7122 extends in the first orientation and the fourth orientation from the second facing portion 7123.

As shown in FIG. 11, the case 700 is provided with a first engaged portion 730 and a second engaged portion 740.

As shown in FIG. 11, the first engaged portion 730 of the present embodiment faces in the second orientation of the predetermined direction. The first engaged portion 730 is located in the second orientation beyond the first facing portion 7113. The case 700 of the present embodiment has no supporting portion which resiliently supports the first engaged portion 730.

As shown in FIG. 11, the second engaged portion 740 of the present embodiment faces in the second orientation of the predetermined direction. The second engaged portion 740 is located in the second orientation beyond the second facing portion 7123. The second engaged portion 740 is located at the same position as the first engaged portion 730 in the predetermined direction. The second engaged portion 740 is located at the same position as the first engaged portion 730 in the width direction. The case 700 of the present embodiment has no supporting portion which resiliently supports the second engaged portion 740.

As shown in FIG. 11, the case 700 is provided with a first recessed portion 750 and a second recessed portion 760.

As shown in FIG. 11, the first recessed portion 750 of the present embodiment is recessed in the third orientation. The first recessed portion 750 is located in the second orientation beyond the first facing portion 7113. The first engaged portion 730 is a part of an inner surface of the first recessed portion 750.

As shown in FIG. 11, the second recessed portion 760 of the present embodiment is recessed in the fourth orientation. The second recessed portion 760 is located in the second orientation beyond the second facing portion 7123. The second engaged portion 740 is a part of an inner surface of the second recessed portion 760. The second recessed portion 760 is located at the same position as the first recessed portion 750 in the predetermined direction. The second recessed portion 760 is located at the same position as the first recessed portion 750 in the width direction.

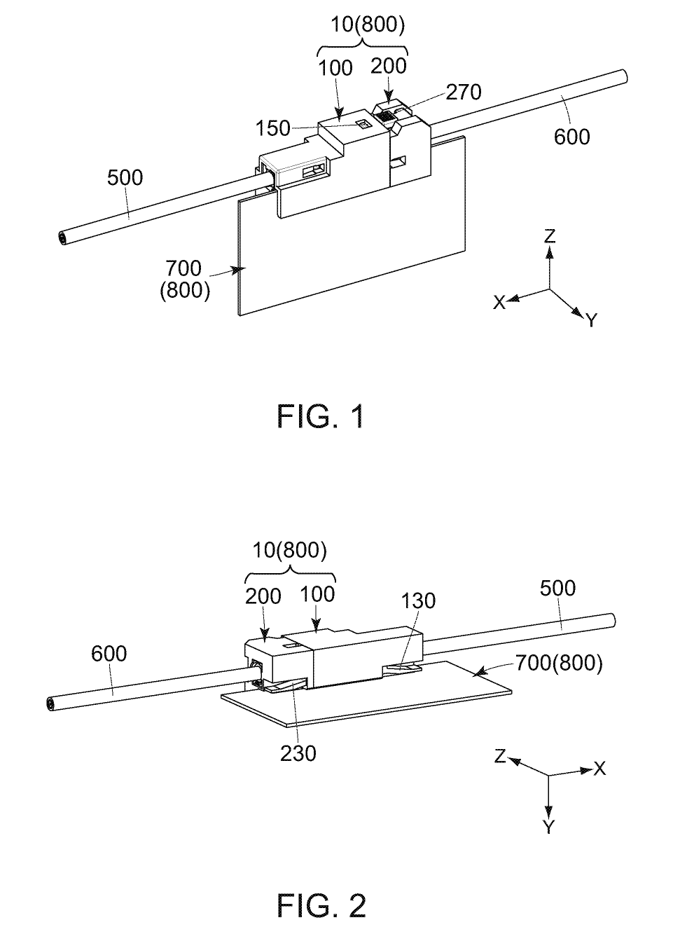

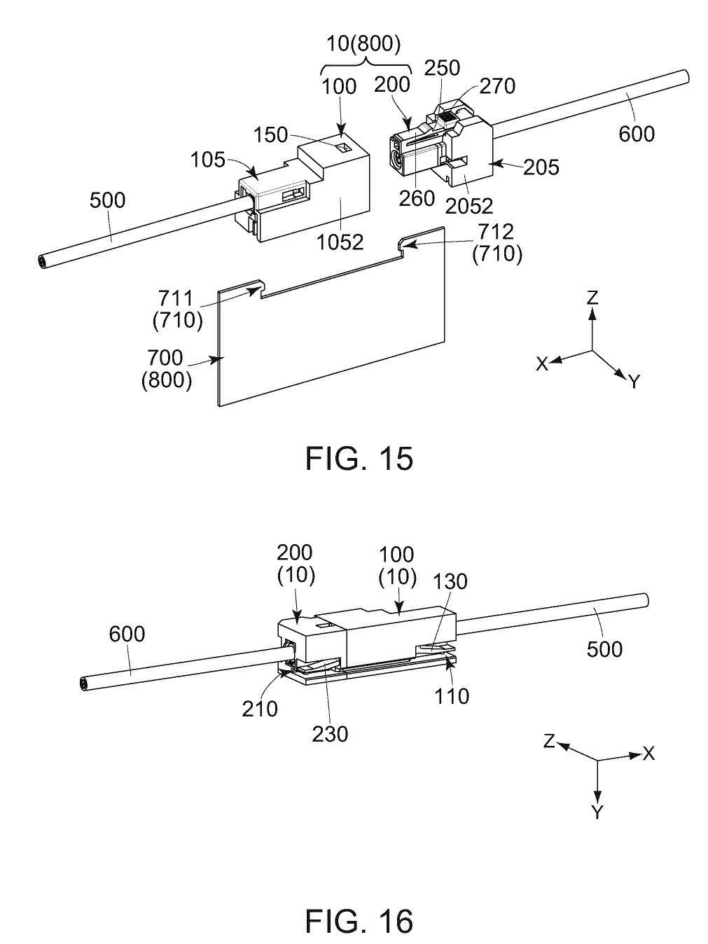

As shown in FIG. 1, the connector assembly 10 of the present embodiment is attachable to the case 700. More specifically, the connector assembly 10 is attachable to the case 700 along the predetermined direction. As shown in FIG. 15, the connector assembly 10 comprises a first connector 100 and a second connector 200 which are mateable with each other. As shown in FIG. 4, the connector assembly 10 is attachable to the case 700 in a completely mated state where the first connector 100 and the second connector 200 are completely mated with each other. More in detail, the connector assembly 10 is attachable to the case 700 only in the completely mated state where the first connector 100 and the second connector 200 are completely mated with each other. In other words, the structure 800 is configured so that the connector assembly 10 cannot be attached to the case 700 while the connector assembly 10 maintains a middle-of-mating state where the first connector 100 and the second connector 200 are not completely mated with each other. The term “completely mated state” in this specification refers to a state where the first connector 100 and the second connector 200 are mated with each other within their effective engagement lengths in the predetermined direction.

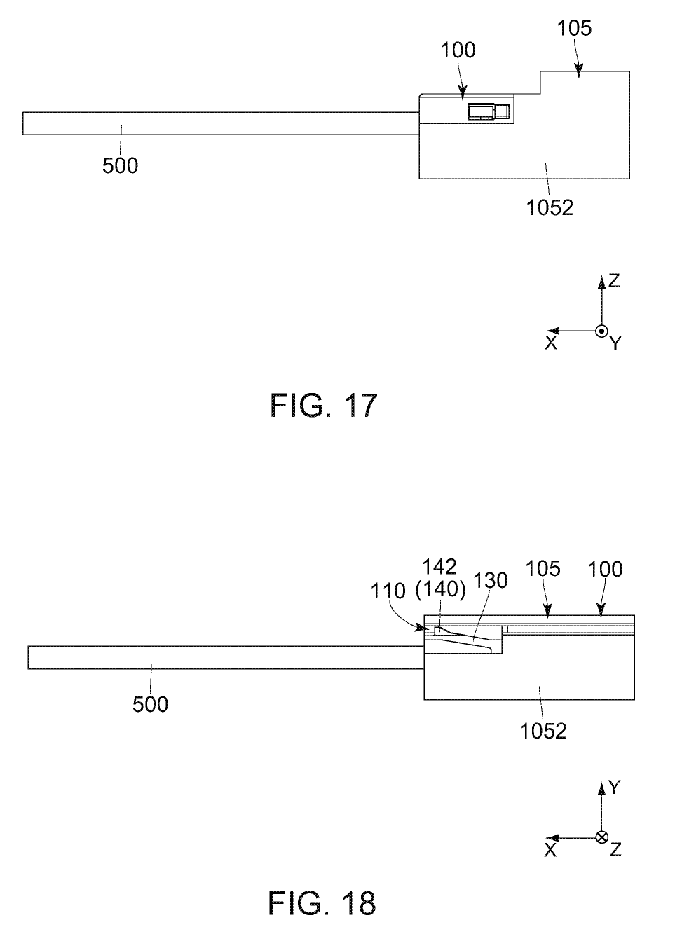

As shown in FIG. 20, the first connector 100 of the present embodiment is an electrical connector. As shown in FIG. 17, the first connector 100 is configured to be connected to a first cable 500. As shown in FIG. 16, the first connector 100 is located beyond the second connector 200 in the third orientation of the perpendicular direction. As shown in FIG. 11, the first connector 100 has a first position-regulating portion 110.

As shown in FIG. 11, the first position-regulating portion 110 of the present embodiment is located at an end of the first connector 100 in the third orientation. The first position-regulating portion 110 is a receiving portion which is able to receive the first position-regulated portion 711. More in detail, the first position-regulating portion 110 is a groove extending in the plane defined by the predetermined direction and the perpendicular direction. As shown in FIG. 4, when the connector assembly 10 in the completely mated state is attached to the case 700, the first position-regulating portion 110 receives the first position-regulated portion 711. The groove functioning as the first position-regulating portion 110 should receive the first position-regulated portion 711 of the case 700 whose plate member has dimensions within their tolerances, provided that the connector assembly 10 in the completely mated state is attachable to the case 700.

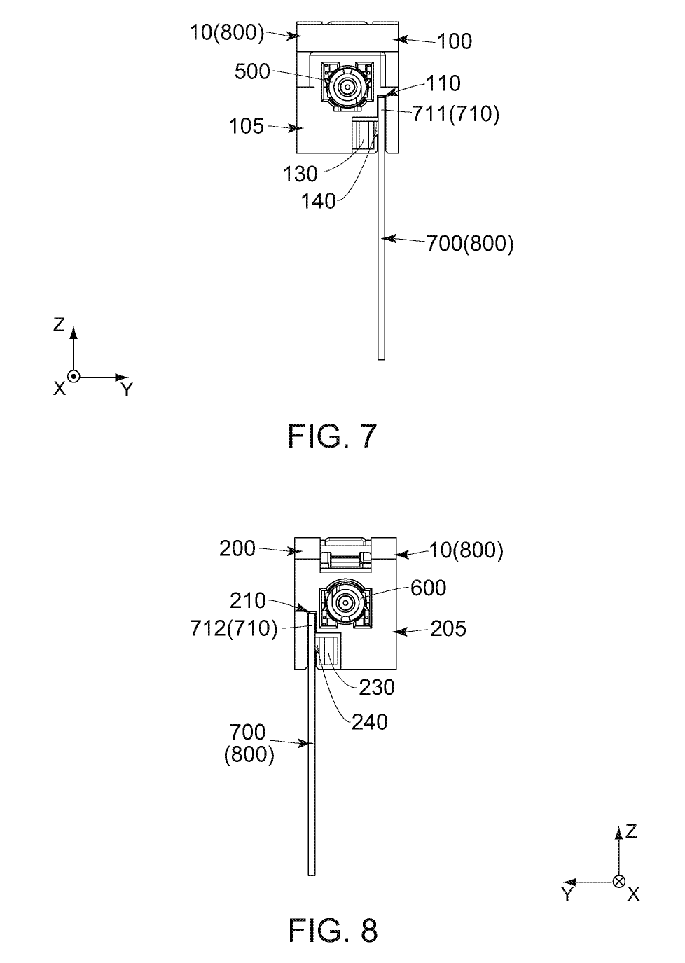

As shown in FIG. 4, when the connector assembly 10 in the completely mated state is attached to the case 700, the first position-regulating portion 110 regulates a position of the first position-regulated portion 711 in the perpendicular direction. More in detail, referring to FIGS. 4 and 7, when the connector assembly 10 in the completely mated state is attached to the case 700, the first position-regulating portion 110 regulates the position of the first position-regulated portion 711 in a plane perpendicular to the predetermined direction.

As shown in FIG. 11, the first position-regulating portion 110 has a first connector facing portion 111.

As shown in FIG. 11, the first connector facing portion 111 of the present embodiment intersects with the perpendicular direction. The first connector facing portion 111 is directed in the third orientation. As shown in FIG. 4, when the connector assembly 10 in the completely mated state is attached to the case 700, the first connector facing portion 111 is located in the fourth orientation beyond the first facing portion 7113 and faces the first facing portion 7113 in the perpendicular direction.

As shown in FIG. 17, the first connector 100 has a first housing 105. The first housing 105 is made of insulator. In the predetermined direction, the first housing 105 defines an end of the first connector 100 in the first orientation and also defines an end of the first connector 100 in the second orientation. In the perpendicular direction, the first housing 105 defines an end of the first connector 100 in the third orientation and also defines an end of the first connector 100 in the fourth orientation. The first housing 105 has a first body portion 1052.

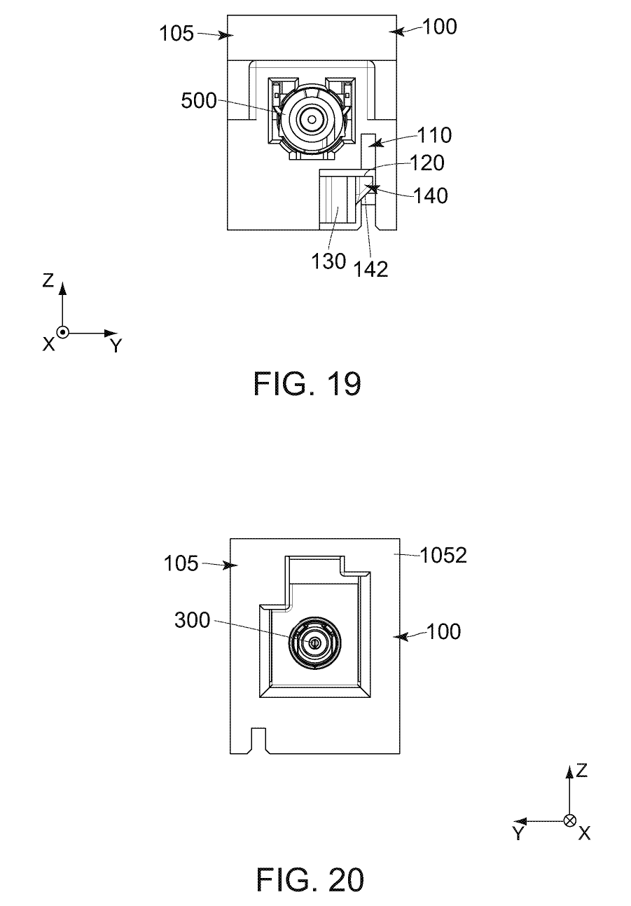

As shown in FIG. 19, the first connector 100 is provided with a first engaging portion 120. The first engaging portion 120 is a part of the first housing 105. The first engaging portion 120 faces in the first orientation. The first engaging portion 120 is perpendicular to the predetermined direction.

As shown in FIG. 19, the first connector 100 has a first supporting portion 130. However, the present invention is not limited thereto. Specifically, the first connector 100 may have no first supporting portion 130. The first supporting portion 130 is a part of the first housing 105. The first supporting portion 130 is elastically deformable. The first supporting portion 130 supports the first engaging portion 120. As shown in FIG. 11, the first supporting portion 130 extends in the third orientation from the first body portion 1052. The first engaging portion 120 is located at an end portion of the first supporting portion 130 in the third orientation. As described above, the first engaging portion 120 is supported by the first supporting portion 130 which is elastically deformable. Accordingly, the first engaging portion 120 is movable in a direction intersecting with the predetermined direction. More in detail, the first engaging portion 120 is movable in the width direction.

In the first connector 100 of the present embodiment, both of the first engaging portion 120 and the first supporting portion 130 are integrally formed with the first body portion 1052. However, the present invention is not limited thereto. Specifically, the first connector 100 may be modified as follows: the first engaging portion 120 and the first supporting portion 130 are formed from a metal member which is distinct and separated from the first body portion 1052; and the metal member is held by the first body portion 1052 by, for example, press-fitting it thereinto.

As shown in FIG. 19, the first connector 100 has a first protruding portion 140.

As shown in FIG. 19, the first protruding portion 140 of the present embodiment is a part of the first housing 105. The first protruding portion 140 is supported by the first supporting portion 130. The first engaging portion 120 is provided on the first protruding portion 140. More in detail, the first engaging portion 120 is an end surface of the first protruding portion 140 in the first orientation. The first protruding portion 140 has a first inclined surface 142. The first inclined surface 142 is oblique to both the predetermined direction and the width direction. As shown in FIG. 4, when the connector assembly 10 in the completely mated state is attached to the case 700, the first protruding portion 140 is received in the first recessed portion 750.

As shown in FIG. 15, the first connector 100 has a locked portion 150.

As shown in FIG. 15, the locked portion 150 of the present embodiment is a surface intersecting with the perpendicular direction. The locked portion 150 faces in the third orientation. The locked portion 150 is located at an end portion of the first connector 100 in the first orientation. The locked portion 150 is located around an end portion of the first connector 100 in the fourth orientation. The locked portion 150 is provided on the first housing 105. More in detail, the locked portion 150 is provided on the first body portion 1052.

As shown in FIG. 20, the first connector 100 has a first contact 300. The first contact 300 is a so-called pin contact made of metal. The first contact 300 is held by the first housing 105. More in detail, the first contact 300 is held by the first body portion 1052.

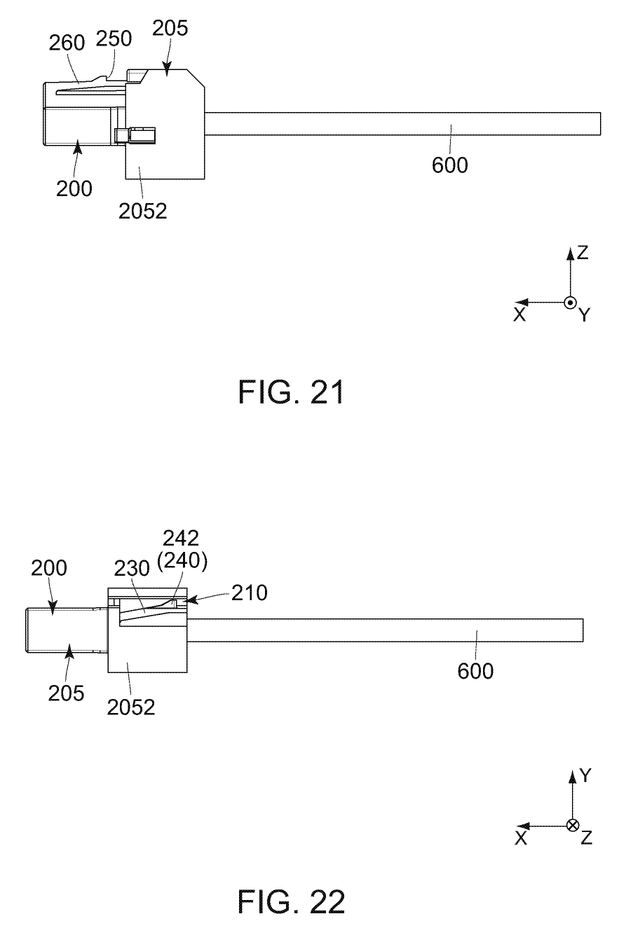

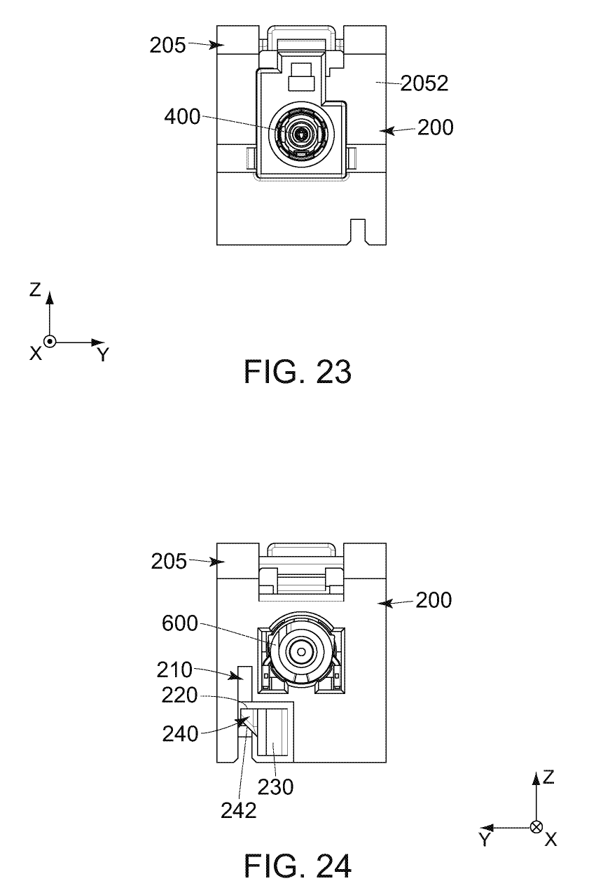

As shown in FIG. 23, the second connector 200 of the present embodiment is an electrical connector. As shown in FIG. 21, the second connector 200 is configured to be connected to a second cable 600. As shown in FIG. 11, the second connector 200 is located beyond the first connector 100 in the fourth orientation of the perpendicular direction. The second connector 200 has a second position-regulating portion 210.

As shown in FIG. 11, the second position-regulating portion 210 of the present embodiment is located at an end portion of the second connector 200 in the fourth orientation. As shown in FIG. 8, the second position-regulating portion 210 is a receiving portion which is able to receive the second position-regulated portion 712. More in detail, as shown in FIG. 24, the second position-regulating portion 210 is a groove extending in the plane defined by the predetermined direction and the perpendicular direction. As shown in FIG. 4, when the connector assembly 10 in the completely mated state is attached to the case 700, the second position-regulating portion 210 receives the second position-regulated portion 712. The groove functioning as the second position-regulating portion 210 should receive the second position-regulated portion 712 of the case 700 whose plate member has the dimensions within their tolerances, provided that the connector assembly 10 in the completely mated state is attachable to the case 700.

Referring to FIG. 4, the second position-regulating portion 210 regulates a position of the second position-regulated portion 712 in the perpendicular direction. More in detail, referring to FIGS. 4 and 8, when the connector assembly 10 in the completely mated state is attached to the case 700, the second position-regulating portion 210 regulates the position of the second position-regulated portion 712 in the plane perpendicular to the predetermined direction.

As shown in FIG. 11, the second position-regulating portion 210 has a second connector facing portion 211.

As shown in FIG. 11, the second connector facing portion 211 of the present embodiment intersects with the perpendicular direction. The second connector facing portion 211 is directed in the fourth orientation. As shown in FIG. 4, when the connector assembly 10 in the completely mated state is attached to the case 700, the second connector facing portion 211 is located in the third orientation beyond the second facing portion 7123 and faces the second facing portion 7123 in the perpendicular direction.

As described above, the connector assembly 10 is configured as follows: the connector assembly 10 is attachable to the case 700 in the completely mated state where the first connector 100 and the second connector 200 are completely mated with each other; and, when the connector assembly 10 in the completely mated state is attached to the case 700, the first position-regulating portion 110 receives the first position-regulated portion 711 while the second position-regulating portion 210 receives the second position-regulated portion 712. This prevents the connector assembly 10 of the present embodiment from being attached to the case 700 in the middle-of-mating state where the first connector 100 and the second connector 200 are not completely mated with each other. In other words, the connector assembly 10 of the present embodiment more reliably assures the complete mating of the first connector 100 with the second connector 200.

As shown in FIG. 21, the second connector 200 has a second housing 205. The second housing 205 is made of insulator. In the predetermined direction, the second housing 205 defines an end of the second connector 200 in the first orientation and also defines an end of the second connector 200 in the second orientation. In the perpendicular direction, the second housing 205 defines an end of the second connector 200 in the third orientation and also defines an end of the second connector 200 in the fourth orientation. The second housing 205 has a second body portion 2052.

As shown in FIG. 24, the second connector 200 is provided with a second engaging portion 220. The second engaging portion 220 is a part of the second housing 205. The second engaging portion 220 faces in the first orientation of the predetermined direction. The second engaging portion 220 is perpendicular to the predetermined direction.

As shown in FIG. 24, the second connector 200 has a second supporting portion 230. However, the present invention is not limited thereto. Specifically, the second connector 200 may have no second supporting portion 230. The second supporting portion 230 is a part of the second housing 205. The second supporting portion 230 is elastically deformable. The second supporting portion 230 supports the second engaging portion 220. As shown in FIG. 11, the second supporting portion 230 extends in the fourth orientation from the second body portion 2052. The second engaging portion 220 is located at an end portion of the second supporting portion 230 in the fourth orientation. As described above, the second engaging portion 220 is supported by the second supporting portion 230 which is elastically deformable. Accordingly, the second engaging portion 220 is movable in a direction intersecting with the predetermined direction. More in detail, the second engaging portion 220 is movable in the width direction.

In the second connector 200 of the present embodiment, both of the second engaging portion 220 and the second supporting portion 230 are integrally formed with the second body portion 2052. However, the present invention is not limited thereto. Specifically, the second connector 200 may be modified as follows: the second engaging portion 220 and the second supporting portion 230 are formed from a metal member which is distinct and separated from the second body portion 2052; and the metal member is held by the second body portion 2052 by, for example, press-fitting it thereinto.

As shown in FIG. 24, the second connector 200 has a second protruding portion 240.

As shown in FIG. 24, the second protruding portion 240 of the present embodiment is a part of the second housing 205. The second protruding portion 240 is supported by the second supporting portion 230. The second engaging portion 220 is provided on the second protruding portion 240. More in detail, the second engaging portion 220 is an end surface of the second protruding portion 240 in the first orientation. The second protruding portion 240 has a second inclined surface 242. The second inclined surface 242 is oblique to both the predetermined direction and the width direction. As shown in FIG. 4, when the connector assembly 10 in the completely mated state is attached to the case 700, the second protruding portion 240 is received in the second recessed portion 760.

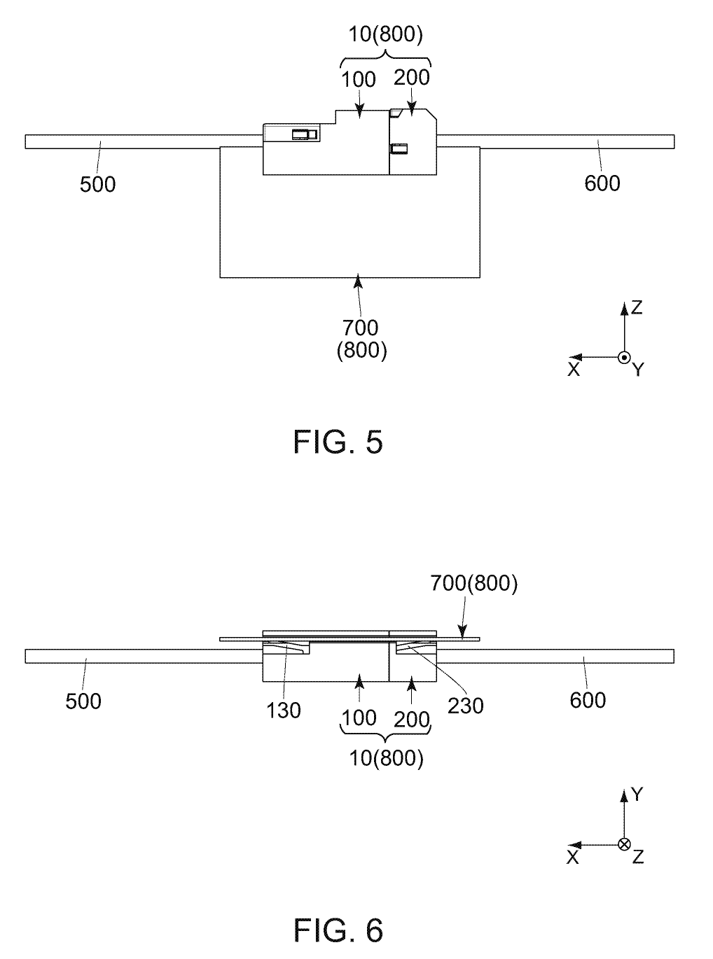

In the structure 800 of the present embodiment, the connector assembly 10 in the completely mated state is attached to the case 700 as follows. First, the connector assembly 10 in the completely mated state approaches the case 700 in the predetermined direction. Then, the first inclined surface 142 of the first protruding portion 140 abuts against the first guide portion 7112 while the second inclined surface 242 of the second protruding portion 240 abuts against the second guide portion 7122. From this state, the connector assembly 10 further approaches the case 700 in the predetermined direction. Then, the first supporting portion 130 is elastically deformed and the first protruding portion 140 rides on the first position-regulated portion 711. At this time, the second supporting portion 230 is elastically deformed and the second protruding portion 240 rides on the second position-regulated portion 712. After that, the connector assembly 10 still further approaches the case 700 in the predetermined direction. Then, the first position-regulating portion 110 receives the first position-regulated portion 711 while the second position-regulating portion 210 receives the second position-regulated portion 712. At this time, the first protruding portion 140 rides over the first position-regulated portion 711 and is accommodated in the first recessed portion 750. Also, at this time, the second protruding portion 240 rides over the second position-regulated portion 712 and is accommodated in the second recessed portion 760. Accordingly, the structure 800 changes its state into a state shown in each of FIGS. 1 to 8, and the attachment of the connector assembly 10 to the case 700 is completed. In this state, the first engaging portion 120 and the first engaged portion 730 face each other in the predetermined direction while the second engaging portion 220 and the second engaged portion 740 face each other in the predetermined direction. Accordingly, even if force in the first orientation is applied to the connector assembly 10 attached to the case 700, the first engaging portion 120 is engaged with the first engaged portion 730 while the second engaging portion 220 is engaged with the second engaged portion 740, and this prevents removal of the connector assembly 10 from the case 700. In other words, when the connector assembly 10 in the completely mated state is attached to the case 700, the first engaging portion 120 and the first engaged portion 730 face each other in the predetermined direction while the second engaging portion 220 and the second engaged portion 740 face each other in the predetermined direction, and this prevents the removal of the connector assembly 10 from the case 700.

Referring to FIG. 14, the connector assembly 10 in the middle-of-mating state has a distance Dc between the first position-regulating portion 110 of the first connector 100 and the second position-regulating portion 210 of the second connector 200, and the case 700 has a distance Dh between the first position-regulated portion 711 and the second position-regulated portion 712, and the distance Dc is greater than the distance Dh. Accordingly, the structure 800 of the present embodiment is configured as follows: if the connector assembly 10 in the middle-of-mating state is intended to be attached to the case 700, the receipt of the first position-regulated portion 711 in the first position-regulating portion 110 and the receipt of the second position-regulated portion 712 in the second position-regulating portion 210 cannot be performed simultaneously while the connector assembly 10 maintains the middle-of-mating state.

As described above, the first position-regulated portion 711 is provided with the first guide portion 7112 oblique to the predetermined direction, and the second position-regulated portion 712 is provided with the second guide portion 7122 oblique to the predetermined direction. Accordingly, when the connector assembly 10 in the middle-of-mating state is intended to be attached to the case 700, the connector assembly 10 can be attached to the case 700 while the state of the connector assembly 10 is changed from the middle-of-mating state to the completely mated state.

Referring to FIG. 14, hereinafter, an explanation will be provided regarding functions and movements of the components of the structure 800 when the connector assembly 10 in the middle-of-mating state is intended to be attached to the case 700. First, the connector assembly 10 in the middle-of-mating state approaches the case 700 in the predetermined direction. Then, the first connector facing portion 111 abuts against the first guide portion 7112 while the second connector facing portion 211 abuts against the second guide portion 7122. From this state, force is applied to the connector assembly 10 so that the connector assembly 10 further approaches the case 700 in the predetermined direction. Then, force in the fourth orientation is applied to the first connector facing portion 111 and thereby the first connector 100 is moved relative to the second connector 200 in a direction in which the first connector 100 approaches the second connector 200. At this time, force in the third orientation is applied to the second connector facing portion 211 and thereby the second connector 200 is moved relative to the first connector 100 in a direction in which the second connector 200 approaches the first connector 100. This causes the state of the first connector 100 and the second connector 200 to be changed from the middle-of-mating state to the completely mated state. From this state, the connector assembly 10 still further approaches the case 700 in the predetermined direction. Then, the first position-regulated portion 711 is received in the first position-regulating portion 110 while the second position-regulated portion 712 is received in the second position-regulating portion 210, and thereby the connector assembly 10 in the completely mated state is attached to the case 700.

As shown in FIG. 15, the second connector 200 has a lock portion 250, an elastic supporting portion 260 and an operation portion 270.

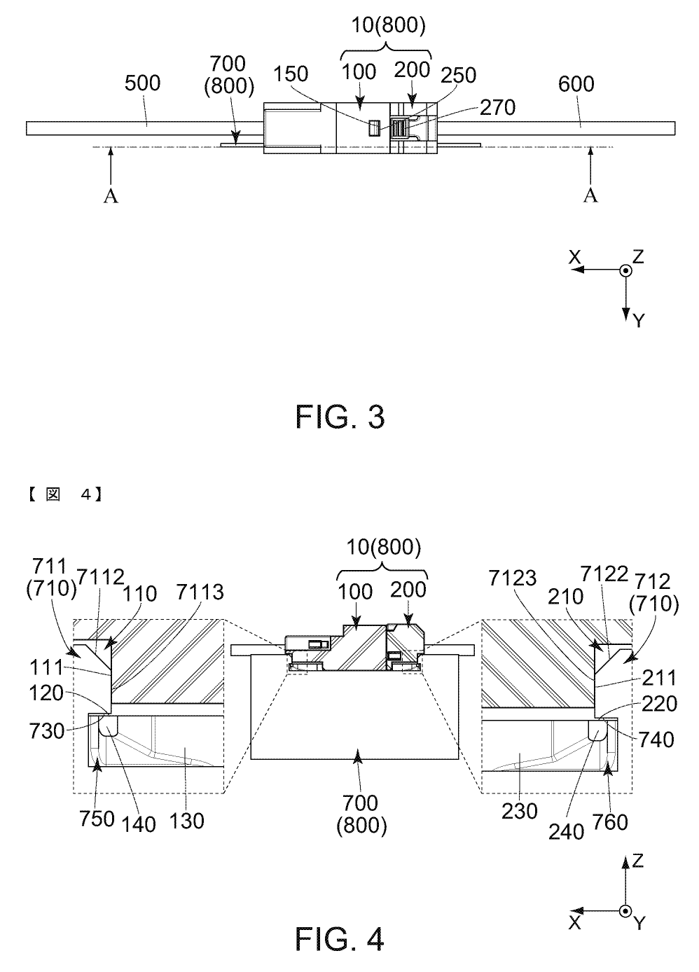

As shown in FIG. 21, the lock portion 250 of the present embodiment is a surface intersecting with the perpendicular direction. The lock portion 250 faces in the fourth orientation. The lock portion 250 is located around an end portion of the second connector 200 in the first orientation. The lock portion 250 is provided on the second housing 205. Referring to FIG. 3, in the completely mated state where the first connector 100 and the second connector 200 are completely mated with each other, the lock portion 250 is located in the third orientation beyond the locked portion 150 and faces the locked portion 150 in the perpendicular direction. In other words, the lock portion 250 and the locked portion 150 lock the mating of the first connector 100 with the second connector 200 in the completely mated state.

As shown in FIG. 21, the elastic supporting portion 260 of the present embodiment is provided on the second housing 205. The elastic supporting portion 260 extends in the fourth orientation from the second body portion 2052. An end portion of the elastic supporting portion 260 in the third orientation is coupled with the second body portion 2052. The elastic supporting portion 260 is elastically deformable. The lock portion 250 is supported by the elastic supporting portion 260. Accordingly, the lock portion 250 is movable in the predetermined direction.

As shown in FIG. 15, the operation portion 270 of the present embodiment is provided on the second housing 205. The operation portion 270 is located at an end portion of the elastic supporting portion 260 in the fourth orientation. As described above, the lock portion 250 is elastically supported by the elastic supporting portion 260. This configuration can perform the following functions: when an operator presses the operation portion 270 in the second orientation, the lock portion 250 is moved in the second orientation; and, when the operator stops pressing the operation portion 270, the elastic supporting portion 260 is restored to its original shape and the lock portion 250 returns to its initial position.

As shown in FIG. 23, the second connector 200 has a second contact 400. The second contact 400 is a so-called socket contact made of metal. The second contact 400 is held by the second housing 205. More in detail, the second contact 400 is held by the second body portion 2052. Referring to FIGS. 1, 20 and 23, in the completely mated state, the second contact 400 is connected with the first contact 300, and the first cable 500 and the second cable 600 are electrically connected with each other.

Although the structure 800 is configured so that, when the connector assembly 10 in the completely mated state is attached to the case 700, the first position-regulating portion 110 receives the first position-regulated portion 711 while the second position-regulating portion 210 receives the second position-regulated portion 712, the present invention is not limited thereto. Specifically, the structure 800 should be configured as follows: when the connector assembly 10 in the completely mated state is attached to the case 700, one of the first position-regulating portion 110 and the first position-regulated portion 711 receives a remaining one of the first position-regulating portion 110 and the first position-regulated portion 711 while one of the second position-regulating portion 210 and the second position-regulated portion 712 receives a remaining one of the second position-regulating portion 210 and the second position-regulated portion 712.

The structure 800 is configured as follows: the first connector 100 has the first supporting portion 130 which supports the first engaging portion 120 and is elastically deformable; the second connector 200 has the second supporting portion 230 which supports the second engaging portion 220 and is elastically deformable; the case 700 has no supporting portion which resiliently supports the first engaged portion 730; and the case 700 has no supporting portion which resiliently supports the second engaged portion 740. However, the present invention is not limited thereto. Specifically, the structure 800 may be modified as follows: the first connector 100 has no first supporting portion 130; the second connector 200 has no second supporting portion 230; and the case 700 has two supporting portions, one of which resiliently supports the first engaged portion 730, and the other of which supports the second engaged portion 740.

### Second embodiment

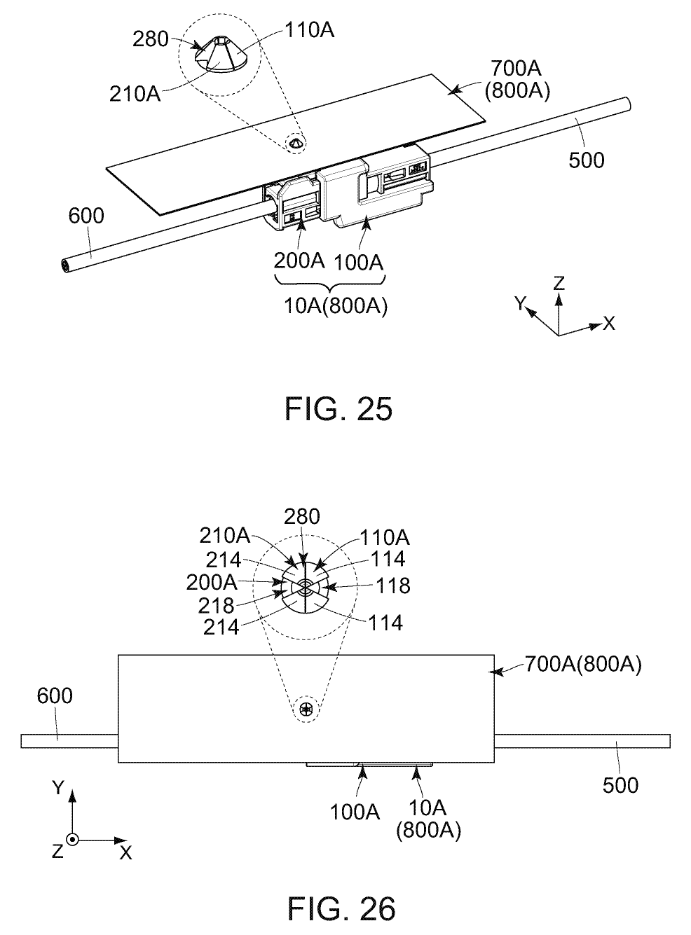

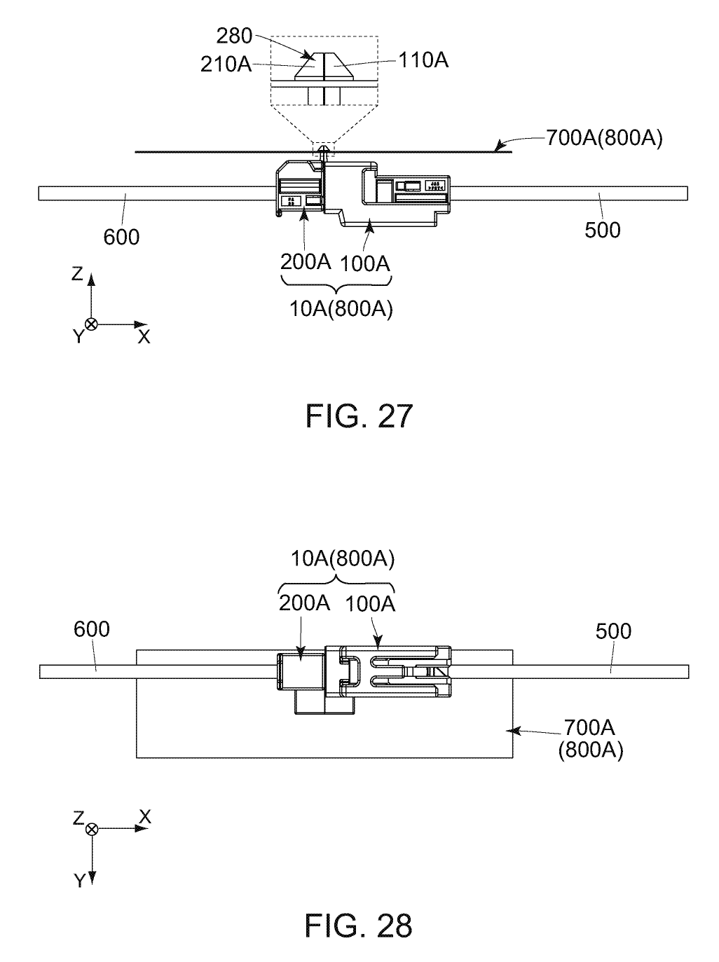

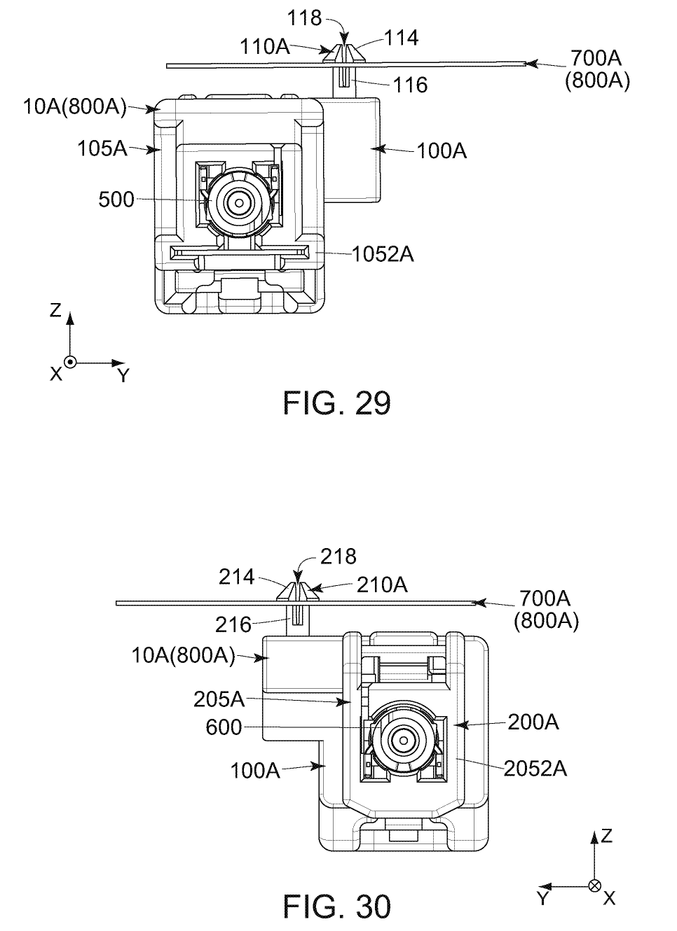

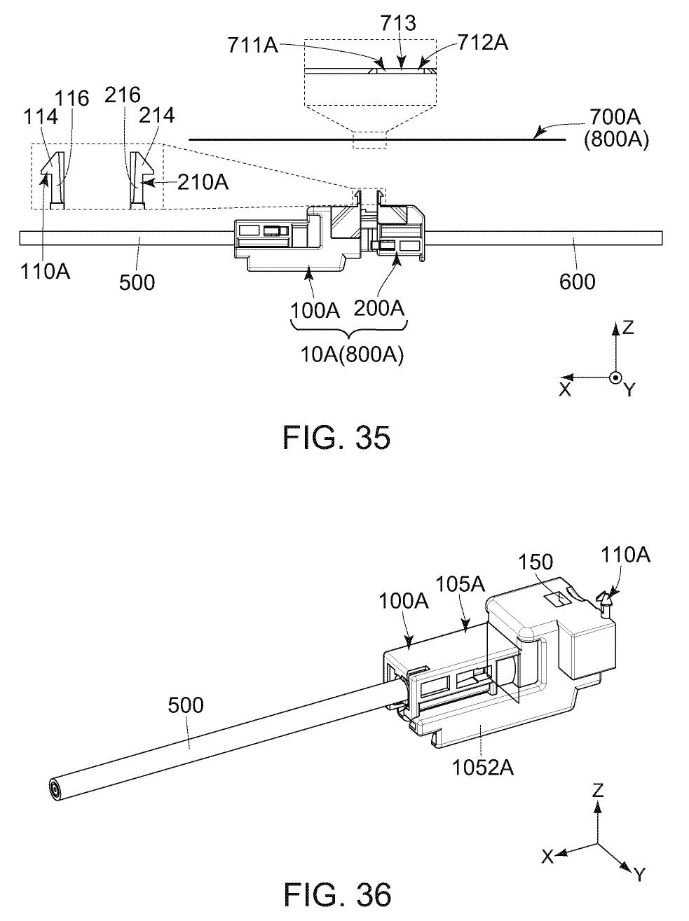

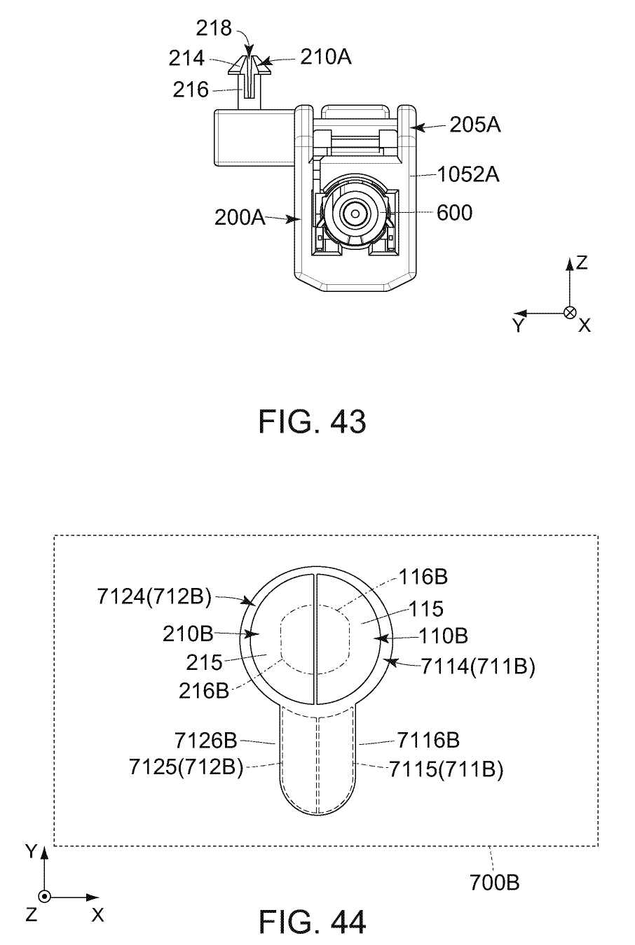

Referring to FIG. 25, a structure 800A according to a second embodiment of the present invention comprises a case 700A and a connector assembly 10A. Specifically, the connector assembly 10A is attachable to the case 700A along the predetermined direction. The structure 800A according to the present embodiment has a configuration similar to that of the structure 800 according to the aforementioned first embodiment as shown in FIG. 1. Components of the structure 800A shown in FIGS. 25 to 43 which are same as those of the structure 800 of the first embodiment are referred to by using reference signs same as those of the structure 800 of the first embodiment. As for directions and orientations in the present embodiment, expressions same as those of the first embodiment will be used hereinbelow.

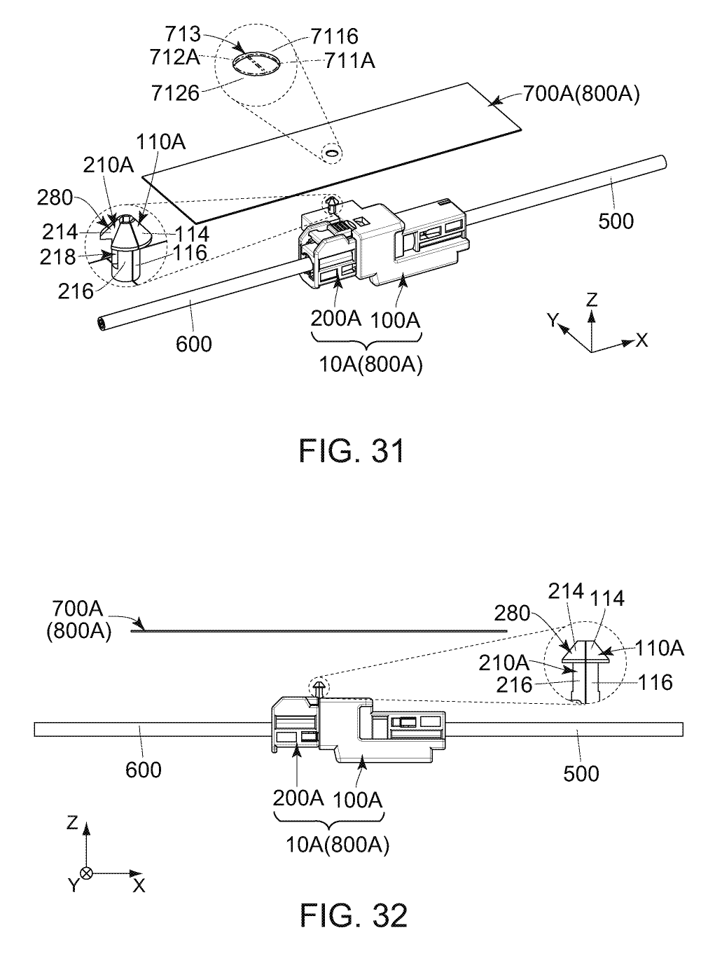

As shown in FIG. 31, the case 700A of the present embodiment is a plate member extending in a plane perpendicular to the predetermined direction. The case 700A has a first position-regulated portion 711A and a second position-regulated portion 712A.

As shown in FIG. 31, the first position-regulated portion 711A of the present embodiment pierces the case 700A in the predetermined direction. The first position-regulated portion 711A and the second position-regulated portion 712A are arranged in the perpendicular direction.

As shown in FIG. 31, the second position-regulated portion 712A of the present embodiment pierces the case 700A in the predetermined direction. The first position-regulated portion 711A and the second position-regulated portion 712A are combined to form a circular hole 713.

As shown in FIG. 31, the case 700A is provided with a first stopper portion 7116 and a second stopper portion 7126.

As shown in FIG. 31, the first stopper portion 7116 of the present embodiment faces in the first orientation of the predetermined direction. The first stopper portion 7116 is located outward of the first position-regulated portion 711A in a direction perpendicular to the predetermined direction.

As shown in FIG. 31, the second stopper portion 7126 of the present embodiment faces in the first orientation of the predetermined direction. The second stopper portion 7126 is located outward of the second position-regulated portion 712A in the direction perpendicular to the predetermined direction.

Referring to FIG. 31, the connector assembly 10A of the present embodiment comprises a first connector 100A and a second connector 200A which are mateable with each other. The connector assembly 10A is attachable to the case 700A in a completely mated state where the first connector 100A and the second connector 200A are completely mated with each other. More in detail, the connector assembly 10A is attachable to the case 700A only in the completely mated state where the first connector 100A and the second connector 200A are completely mated with each other. In other words, the structure 800A is configured so that the connector assembly 10A cannot be attached to the case 700A while the connector assembly 10A maintains a middle-of-mating state where the first connector 100A and the second connector 200A are not completely mated with each other.

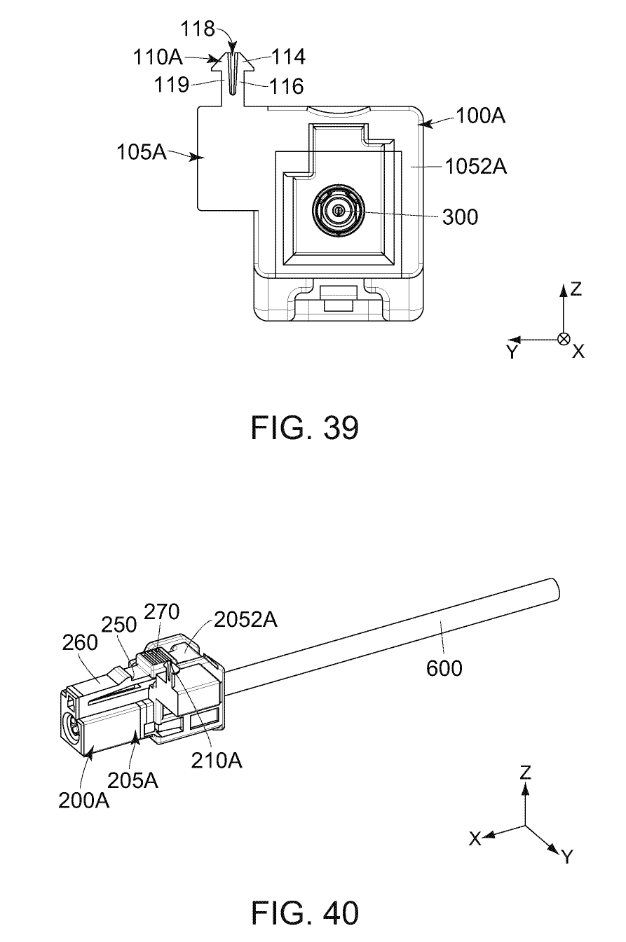

As shown in FIG. 39, the first connector 100A of the present embodiment is an electrical connector. As shown in FIG. 36, the first connector 100A is configured to be connected to a first cable 500. As shown in FIG. 31, the first connector 100A is located beyond the second connector 200A in the third orientation of the perpendicular direction. The first connector 100A has a first position-regulating portion 110A.

Referring to FIG. 31, the first position-regulating portion 110A is a protrusion which is able to be received in the first position-regulated portion 711A. Referring to FIGS. 25 and 31, when the connector assembly 10A in the completely mated state is attached to the case 700A, the first position-regulating portion 110A is received in the first position-regulated portion 711A. As shown in FIG. 39, the first position-regulating portion 110A has a plurality of first hook portions 114, a plurality of first supporting portions 116, a first slit 118 and a first facing surface 119.

As shown in FIG. 39, each of the first hook portions 114 of the present embodiment defines an end of the first connector 100A in the predetermined direction. Specifically, each of the first hook portions 114 defines the end of the first connector 100A in the first orientation. The first hook portions 114 extend from the first supporting portions 116, respectively, outward in the direction perpendicular to the predetermined direction.

As shown in FIG. 39, each of the first supporting portions 116 of the present embodiment extends in the predetermined direction. Each of the first supporting portions 116 is elastically deformable. The first hook portions 114 are elastically supported by the first supporting portions 116, respectively. Accordingly, each of the first hook portions 114 is movable in the plane perpendicular to the predetermined direction. Referring to FIGS. 25 and 31, when the connector assembly 10A in the completely mated state is attached to the case 700A, each of the first supporting portions 116 is received in the first position-regulated portion 711A.

As shown in FIG. 39, the first slit 118 of the present embodiment is located between the first hook portions 114 which are adjacent to each other. The first slit 118 is located between the first supporting portions 116 which are adjacent to each other.

As shown in FIG. 39, the first facing surface 119 of the present embodiment faces in the fourth orientation. The first facing surface 119 intersects with the perpendicular direction. More in detail, the first facing surface 119 is perpendicular to the perpendicular direction.

Referring to FIGS. 25 and 31, when the connector assembly 10A in the completely mated state is attached to the case 700A, the first position-regulating portion 110A regulates a position of the first position-regulated portion 711A in the perpendicular direction. More in detail, when the connector assembly 10A in the completely mated state is attached to the case 700A, the first position-regulating portion 110A regulates the position of the first position-regulated portion 711A in the plane perpendicular to the predetermined direction.

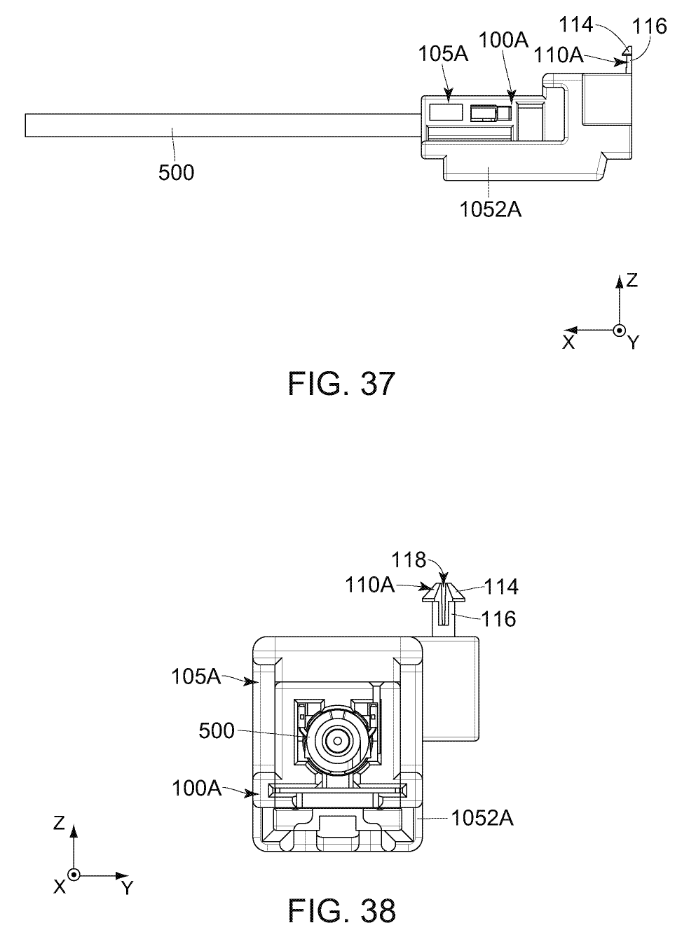

As shown in FIG. 37, the first connector 100A has a first housing 105A. The first housing 105A is made of insulator. In the predetermined direction, the first housing 105A defines an end of the first connector 100A in the first orientation and also defines an end of the first connector 100A in the second orientation. In the perpendicular direction, the first housing 105A defines an end of the first connector 100A in the third orientation and also defines an end of the first connector 100A in the fourth orientation. The first housing 105A has a first body portion 1052A. The first supporting portion 116 couples the first hook portion 114 with the first body portion 1052A.

As shown in FIG. 36, the first connector 100A has a locked portion 150. The locked portion 150 of the present embodiment has a configuration same as that of the locked portion 150 of the first embodiment. Accordingly, a detailed explanation thereabout is omitted.

As shown in FIG. 39, the first connector 100A has a first contact 300. The first contact 300 of the present embodiment has a configuration same as that of the first contact 300 of the first embodiment. Accordingly, a detailed explanation thereabout is omitted.

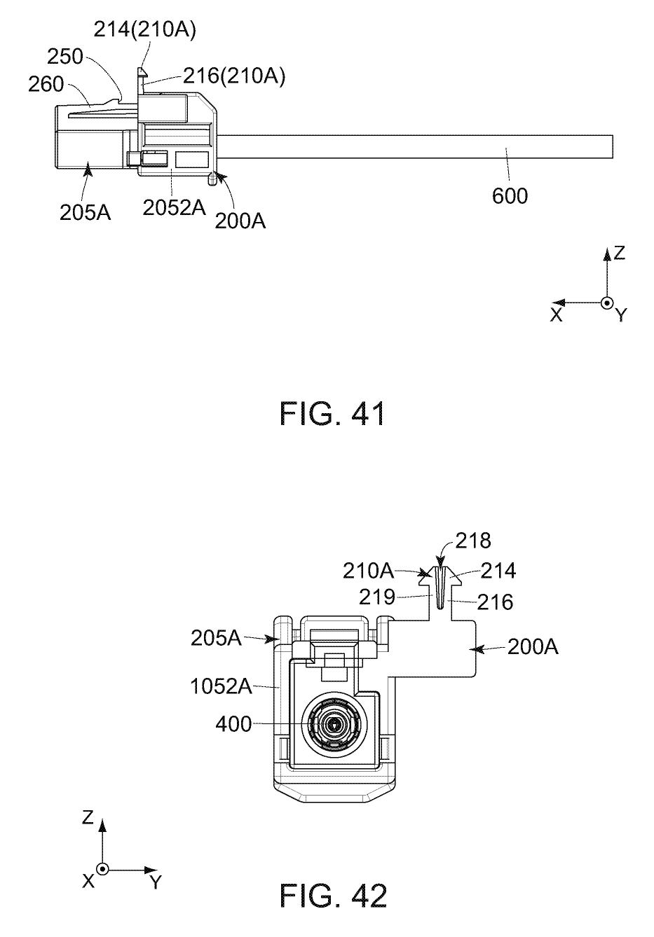

As shown in FIG. 42, the second connector 200A of the present embodiment is an electrical connector. As shown in FIG. 41, the second connector 200A is configured to be connected to a second cable 600. As shown in FIG. 31, the second connector 200A is located beyond the first connector 100A in the fourth orientation of the perpendicular direction. The second connector 200A has a second position-regulating portion 210A.

Referring to FIG. 31, the second position-regulating portion 210A is a protrusion which is able to be received in the second position-regulated portion 712A. Referring to FIGS. 25 and 31, when the connector assembly 10A in the completely mated state is attached to the case 700A, the second position-regulating portion 210A is received in the second position-regulated portion 712A. As shown in FIG. 42, the second position-regulating portion 210A has a plurality of second hook portions 214, a plurality of second supporting portions 216, a second slit 218 and a second facing surface 219.

As shown in FIG. 42, each of the second hook portions 214 of the present embodiment defines an end of the second connector 200A in the predetermined direction. In other words, each of the second hook portions 214 defines the end of the second connector 200A in the first orientation of the predetermined direction. The second hook portions 214 extend from the second supporting portions 216, respectively, outward in the direction perpendicular to the predetermined direction.

As shown in FIG. 42, each of the second supporting portions 216 of the present embodiment extends in the predetermined direction. Each of the second supporting portions 216 is elastically deformable. The second hook portions 214 are elastically supported by the second supporting portions 216, respectively. Accordingly, each of the second hook portions 214 is movable in the plane perpendicular to the predetermined direction. Referring to FIGS. 25 and 31, when the connector assembly 10A in the completely mated state is attached to the case 700A, each of the second supporting portions 216 is received in the second position-regulated portion 712A.

As shown in FIG. 42, the second slit 218 of the present embodiment is located between the second hook portions 214 which are adjacent to each other. The second slit 218 is located between the second supporting portions 216 which are adjacent to each other. As shown in FIG. 26, the first hook portions 114, a part of the first slit 118, the second hook portions 214 and a part of the second slit 218 constitute a head portion 280 in the completely mated state. Referring to FIG. 31, in the plane perpendicular to the predetermined direction, a size of the head portion 280 in a state where none of the first supporting portions 116 and the second supporting portions 216 are elastically deformed is greater than a size of the hole 713.

As shown in FIG. 42, the second facing surface 219 of the present embodiment faces in the third orientation. The second facing surface 219 intersects with the perpendicular direction. More in detail, the second facing surface 219 is perpendicular to the perpendicular direction. In the completely mated state, the second facing surface 219 faces the first facing surface 119 in the perpendicular direction. Referring to FIGS. 31, 39 and 42, in the completely mated state, the second facing surface 219 is in contact with the first facing surface 119 in the perpendicular direction.

As described above, the connector assembly 10A is configured as follows: the connector assembly 10A is attachable to the case 700A in the completely mated state where the first connector 100A and the second connector 200A are completely mated with each other; and, when the connector assembly 10A in the completely mated state is attached to the case 700A, the first position-regulating portion 110A is received in the first position-regulated portion 711A while the second position-regulating portion 210A is received in the second position-regulated portion 712A. This prevents the connector assembly 10A of the present embodiment from being attached to the case 700A in the middle-of-mating state where the first connector 100A and the second connector 200A are not completely mated with each other. In other words, the connector assembly 10A of the present embodiment more reliably assures the complete mating of the first connector 100A with the second connector 200A.

As shown in FIG. 41, the second connector 200A has a second housing 205A. The second housing 205A is made of insulator. In the predetermined direction, the second housing 205A defines an end of the second connector 200A in the first orientation and also defines an end of the second connector 200A in the second orientation. In the perpendicular direction, the second housing 205A defines an end of the second connector 200A in the third orientation and also defines an end of the second connector 200A in the fourth orientation. The second housing 205A has a second body portion 2052A. The second supporting portion 216 couples the second hook portion 214 with the second body portion 2052A.

In the structure 800A of the present embodiment, the connector assembly 10A in the completely mated state is attached to the case 700A as follows. First, the connector assembly 10A in the completely mated state approaches the case 700A in the predetermined direction. Then, each of the first hook portions 114 abuts against a periphery of the first position-regulated portion 711A while each of the second hook portions 214 abuts against a periphery of the second position-regulated portion 712A. From this state, the connector assembly 10A further approaches the case 700A in the predetermined direction. Then, each of the first supporting portions 116 is elastically deformed so that the first hook portions 114 approach each other. At this time, each of the second supporting portions 216 is elastically deformed so that the second hook portions 214 approach each other. Accordingly, in the plane perpendicular to the predetermined direction, the size of the head portion 280 becomes equal or smaller than the size of the hole 713. From this state, the connector assembly 10A still further approaches the case 700A in the predetermined direction. Then, each of the first hook portions 114 passes through the first position-regulated portion 711A and is moved to be located in the first orientation beyond the first position-regulated portion 711A. At this time, each of the second hook portions 214 passes through the second position-regulated portion 712A and is moved to be located in the first orientation beyond the second position-regulated portion 712A. Thus, each of the first supporting portions 116 of the first position-regulating portion 110A is received in the first position-regulated portion 711A while each of the first supporting portions 116 is restored to its original shape. At this time, each of the second supporting portions 216 of the second position-regulating portion 210A is received in the second position-regulated portion 712A while each of the second supporting portions 216 is restored to its original shape. Consequently, the structure 800A changes its state into a state shown in each of FIGS. 25 to 30, and the attachment of the connector assembly 10A to the case 700A is completed. In this state, an end portion of each of the first hook portions 114 in the second orientation is located in the first orientation beyond the first stopper portion 7116 shown in FIG. 31, while the end portion faces the first stopper portion 7116 in the predetermined direction. Also, in this state, an end portion of each of the second hook portions 214 in the second orientation is located in the first orientation beyond the second stopper portion 7126 shown in FIG. 31, while the end portion faces the second stopper portion 7126 in the predetermined direction. Accordingly, even if force in the second orientation is applied to the connector assembly 10A attached to the case 700A, each of the first hook portions 114 is engaged with the first stopper portion 7116 while each of the second hook portions 214 is engaged with the second stopper portion 7126, and this prevents removal of the connector assembly 10A from the case 700A.

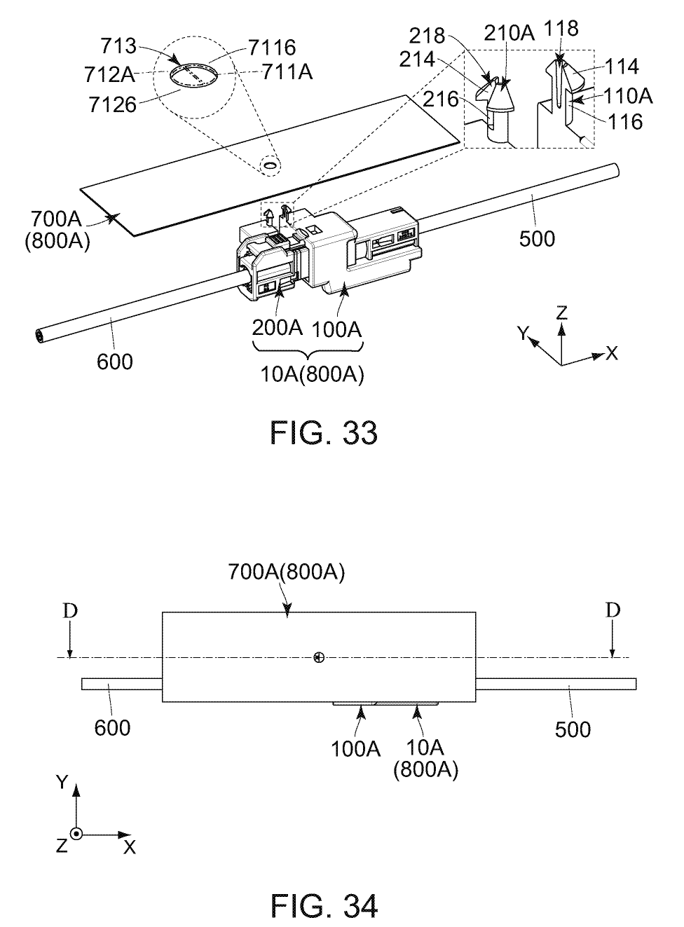

Referring to FIG. 33, the structure 800A of the present embodiment is configured as follows: if the connector assembly 10A in the middle-of-mating state is intended to be attached to the case 700A, the receipt of the first position-regulating portion 110A in the first position-regulated portion 711A and the receipt of the second position-regulating portion 210A in the second position-regulated portion 712A cannot be performed simultaneously while the connector assembly 10A maintains the middle-of-mating state.

As shown in FIG. 40, the second connector 200A has a lock portion 250, an elastic supporting portion 260 and an operation portion 270. The lock portion 250, the elastic supporting portion 260 and the operation portion 270 of the present embodiment have configurations same as those of the lock portion 250, the elastic supporting portion 260 and the operation portion 270 of the first embodiment. Accordingly, a detailed explanation thereabout is omitted.

Referring to FIGS. 31, 36 and 40, in the completely mated state where the first connector 100A and the second connector 200A are completely mated with each other, the lock portion 250 is located in the third orientation beyond the locked portion 150 and faces the locked portion 150 in the perpendicular direction. In other words, the lock portion 250 and the locked portion 150 lock the mating of the first connector 100A with the second connector 200A in the completely mated state.

As shown in FIG. 42, the second connector 200A has a second contact 400. The second contact 400 of the present embodiment has a configuration same as that of the second contact 400 of the first embodiment. Accordingly, a detailed explanation thereabout is omitted. Referring to FIGS. 31, 39 and 42, in the completely mated state, the second contact 400 is connected with the first contact 300, and the first cable 500 and the second cable 600 are electrically connected with each other.

The structure 800A of the present embodiment may be modified as below.

### First modification

Referring to FIG. 44, a structure (not shown) of a first modification comprises a case 700B and a connector assembly (not shown). Specifically, the case 700B has a first position-regulated portion 711B and a second position-regulated portion 712B, and the connector assembly is attachable to the case 700B along the predetermined direction.

As shown in FIG. 44, the first position-regulated portion 711B of the present modification has a first main receipt portion 7114 and a first sub receipt portion 7115.

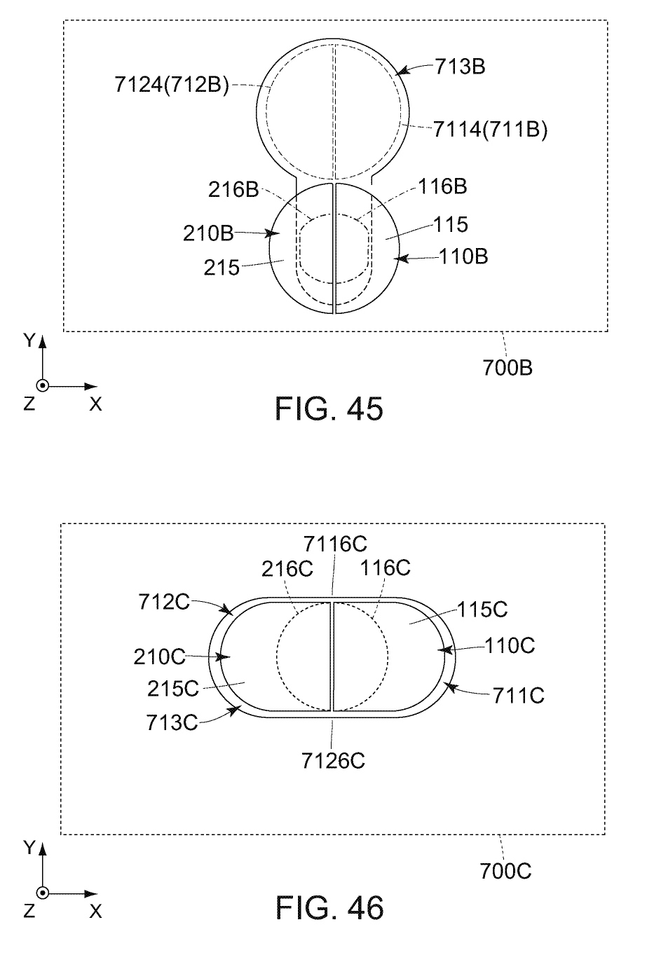

As shown in FIG. 45, the first main receipt portion 7114 of the present modification pierces the case 700B in the predetermined direction.

As shown in FIG. 44, the first sub receipt portion 7115 of the present modification pierces the case 700B in the predetermined direction. The first sub receipt portion 7115 is coupled with the first main receipt portion 7114 in the width direction.

As shown in FIG. 44, the case 700B of the present modification has a first stopper portion 7116B.

As shown in FIG. 44, the first stopper portion 7116B of the present modification faces in the first orientation. The first stopper portion 7116B is perpendicular to the predetermined direction. The first stopper portion 7116B is located in the third orientation beyond the first sub receipt portion 7115.

As shown in FIG. 44, the second position-regulated portion 712B of the present modification has a second main receipt portion 7124 and a second sub receipt portion 7125.

As shown in FIG. 45, the second main receipt portion 7124 of the present modification pierces the case 700B in the predetermined direction. The second main receipt portion 7124 is located in the fourth orientation beyond the first main receipt portion 7114. The second main receipt portion 7124 is coupled with the first main receipt portion 7114 in the perpendicular direction. The first main receipt portion 7114 and the second main receipt portion 7124 are combined to form a circular hole 713B.

As shown in FIG. 44, the second sub receipt portion 7125 of the present modification pierces the case 700B in the predetermined direction. The second sub receipt portion 7125 is located in the fourth orientation beyond the first sub receipt portion 7115. The second sub receipt portion 7125 is coupled with the second main receipt portion 7124 in the width direction. The first sub receipt portion 7115 and the second sub receipt portion 7125 are coupled with each other in the perpendicular direction.

As shown in FIG. 44, the case 700B of the present modification has a second stopper portion 7126B.

As shown in FIG. 44, the second stopper portion 7126B of the present modification faces in the first orientation. The second stopper portion 7126B is perpendicular to the predetermined direction. The second stopper portion 7126B is located in the fourth orientation beyond the second sub receipt portion 7125.

Referring to FIG. 44, the connector assembly of the present modification comprises a first connector (not shown) and a second connector (not shown) which are mateable with each other. The connector assembly is attachable to the case 700B in a completely mated state where the first connector and the second connector are completely mated with each other. More in detail, the connector assembly is attachable to the case 700B only in the completely mated state where the first connector and the second connector are completely mated with each other. In other words, the structure is configured so that the connector assembly cannot be attached to the case 700B while the connector assembly maintains a middle-of-mating state where the first connector and the second connector are not completely mated with each other. Similar to the first connector 100A of the aforementioned embodiment, the first connector of the present modification is also an electrical connector. The first connector of the present modification has a first position-regulating portion 110B.

Referring to FIG. 44, the first position-regulating portion 110B of the present modification is a protrusion which is able to be received in the first position-regulated portion 711B. The first position-regulating portion 110B has a first extending portion 115 and a first supporting portion 116B.

Referring to FIG. 44, the first extending portion 115 of the present modification defines an end of the first connector in the predetermined direction. Specifically, the first extending portion 115 defines the end of the first connector in the first orientation. The first extending portion 115 extends from the first supporting portion 116B outward in a direction perpendicular to the predetermined direction. In a plane perpendicular to the predetermined direction, a size of the first extending portion 115 is smaller than a size of the first main receipt portion 7114.

Referring to FIG. 44, the first supporting portion 116B of the present modification couples the first extending portion 115 with a first body portion (not shown). In the plane perpendicular to the predetermined direction, a size of the first supporting portion 116B is smaller than the size of the first main receipt portion 7114. In the plane perpendicular to the predetermined direction, the size of the first supporting portion 116B is smaller than the size of the first sub receipt portion 7115.

As shown in FIG. 44, similar to the first connector 100A of the aforementioned embodiment, the second connector of the present modification is also an electrical connector. The second connector has a second position-regulating portion 210B.

Referring to FIG. 44, the second position-regulating portion 210B of the present modification is a protrusion which is able to be received in the second position-regulated portion 712B. The second position-regulating portion 210B has a second extending portion 215 and a second supporting portion 216B.

Referring to FIG. 44, the second extending portion 215 of the present modification defines an end of the second connector in the predetermined direction. Specifically, the second extending portion 215 defines the end of the second connector in the first orientation. The second extending portion 215 extends from the second supporting portion 216B outward in the direction perpendicular to the predetermined direction. In the plane perpendicular to the predetermined direction, a size of the second extending portion 215 is smaller than a size of the second main receipt portion 7124.

Referring to FIG. 44, the second supporting portion 216B of the present modification couples the second extending portion 215 with a second body portion (not shown). In the plane perpendicular to the predetermined direction, a size of the second supporting portion 216B is smaller than the size of the second main receipt portion 7124. In the plane perpendicular to the predetermined direction, the size of the second supporting portion 216B is smaller than a size of the second sub receipt portion 7125.

Referring to FIGS. 44 and 45, the structure of the present modification is configured so that, when the connector assembly in the completely mated state is attached to the case 700B, the first position-regulating portion 110B is received in the first position-regulated portion 711B while the second position-regulating portion 210B is received in the second position-regulated portion 712B.

As described above, the connector assembly of the present modification is configured as follows: the connector assembly is attachable to the case 700B in the completely mated state where the first connector and the second connector are completely mated with each other; and, when the connector assembly in the completely mated state is attached to the case 700B, the first position-regulating portion 110B is received in the first position-regulated portion 711B while the second position-regulating portion 210B is received in the second position-regulated portion 712B. Accordingly, the connector assembly of the present modification is also prevented from being attached to the case 700B in the middle-of-mating state where the first connector and the second connector are not completely mated with each other. In other words, the connector assembly of the present modification also more reliably assures the complete mating of the first connector with the second connector.

In the structure of the present modification, the connector assembly in the completely mated state is attached to the case 700B as follows. First, the connector assembly in the completely mated state approaches the case 700B in the predetermined direction. Then, the first extending portion 115 passes through the first main receipt portion 7114 and is moved to be located in the first orientation beyond the first main receipt portion 7114, while the first supporting portion 116B is received in the first main receipt portion 7114. At this time, the second extending portion 215 passes through the second main receipt portion 7124 and is moved to be located in the first orientation beyond the second main receipt portion 7124, while the second supporting portion 216B is received in the second main receipt portion 7124. Accordingly, the structure changes its state to a state shown in FIGS. 44. From this state, the connector assembly is moved in the sixth orientation relative to the case 700B. Then, the first supporting portion 116B is received in the first sub receipt portion 7115 while the second supporting portion 216B is received in the second sub receipt portion 7125. Thus, the structure changes its state into a state shown in FIG. 45, and the attachment of the connector assembly to the case 700B is completed. In this state, an end portion of the first extending portion 115 in the second orientation is located in the first orientation beyond the first stopper portion 7116B, while the end portion faces the first stopper portion 7116B in the predetermined direction. Also, in this state, an end portion of the second extending portion 215 in the second orientation is located in the first orientation beyond the second stopper portion 7126B, while the end portion faces the second stopper portion 7126B in the predetermined direction. Accordingly, even if force in the second orientation is applied to the connector assembly of the present modification in the state of FIG. 45, the first extending portion 115 is engaged with the first stopper portion 7116B while the second extending portion 215 is engaged with the second stopper portion 7126B, and this prevents removal of the connector assembly from the case 700B.

The structure is configured as follows: if the connector assembly in the middle-of-mating state is intended to be attached to the case 700B, the receipt of the first position-regulating portion 110B in the first position-regulated portion 711B and the receipt of the second position-regulating portion 210B in the second position-regulated portion 712B cannot be performed simultaneously while the connector assembly maintains the middle-of-mating state.

### Second modification

Referring to FIG. 46, a structure (not shown) of a second modification comprises a case 700C and a connector assembly (not shown). Specifically, the case 700C has a first position-regulated portion 711C and a second position-regulated portion 712C, and the connector assembly is attachable to the case 700C along the predetermined direction.

As shown in FIG. 46, the first position-regulated portion 711C of the present modification pierces the case 700C in the predetermined direction.

As shown in FIG. 46, the case 700C of the present modification has a first stopper portion 7116C.

As shown in FIG. 46, the first stopper portion 7116C of the present modification faces in the first orientation. The first stopper portion 7116C is perpendicular to the predetermined direction. The first stopper portion 7116C is located in the fifth orientation beyond the first position-regulated portion 711C.

As shown in FIG. 46, the second position-regulated portion 712C of the present modification pierces the case 700C in the predetermined direction. The second position-regulated portion 712C is located in the fourth orientation beyond the first position-regulated portion 711C. The first position-regulated portion 711C and the second position-regulated portion 712C are coupled with each other in the perpendicular direction. The first position-regulated portion 711C and the second position-regulated portion 712C are combined to form an elongated hole 713C which extends in the perpendicular direction.

As shown in FIG. 46, the case 700C of the present modification has a second stopper portion 7126C.

As shown in FIG. 46, the second stopper portion 7126C of the present modification faces in the first orientation. The second stopper portion 7126C is perpendicular to the predetermined direction. The second stopper portion 7126C is located in the sixth orientation beyond the second position-regulated portion 712C.

Referring to FIG. 46, the connector assembly of the present modification comprises a first connector (not shown) and a second connector (not shown) which are mateable with each other. The connector assembly is attachable to the case 700C in a completely mated state where the first connector and the second connector are completely mated with each other. More in detail, the connector assembly is attachable to the case 700C only in the completely mated state where the first connector and the second connector are completely mated with each other. In other words, the structure is configured so that the connector assembly cannot be attached to the case 700C while the connector assembly maintains a middle-of-mating state where the first connector and the second connector are not completely mated with each other. Similar to the first connector 100A of the aforementioned embodiment, the first connector of the present modification is also an electrical connector. The first connector of the present modification has a first position-regulating portion 110C.

Referring to FIG. 46, the first position-regulating portion 110C of the present modification is a protrusion which is able to be received in the first position-regulated portion 711C. The first position-regulating portion 110C has a first extending portion 115C and a first supporting portion 116C.

Referring to FIG. 46, the first extending portion 115C of the present modification defines an end of the first connector in the predetermined direction. Specifically, the first extending portion 115C defines the end of the first connector in the first orientation. The first extending portion 115C extends in the third orientation from the first supporting portion 116C. In the plane perpendicular to the predetermined direction, a size of the first extending portion 115C is smaller than a size of the first position-regulated portion 711C.

Referring to FIG. 46, the first supporting portion 116C of the present modification couples the first extending portion 115C with a first body portion (not shown). In the plane perpendicular to the predetermined direction, a size of the first supporting portion 116C is smaller than the size of the first position-regulated portion 711C.

As shown in FIG. 46, similar to the first connector 100A of the aforementioned embodiment, the second connector of the present modification is also an electrical connector. The second connector has a second position-regulating portion 210C.

Referring to FIG. 46, the second position-regulating portion 210C of the present modification is a protrusion which is able to be received in the second position-regulated portion 712C. The second position-regulating portion 210C has a second extending portion 215C and a second supporting portion 216C.

Referring to FIG. 46, the second extending portion 215C of the present modification defines an end of the second connector in the predetermined direction. Specifically, the second extending portion 215C defines the end of the second connector in the first orientation of the predetermined direction. The second extending portion 215C extends in the fourth orientation from the second supporting portion 216C. In the plane perpendicular to the predetermined direction, a size of the second extending portion 215C is smaller than a size of the second position-regulated portion 712C.

Referring to FIG. 46, the second supporting portion 216C of the present modification couples the second extending portion 215C with a second body portion (not shown). In the plane perpendicular to the predetermined direction, a size of the second supporting portion 216C is smaller than the size of the second position-regulated portion 712C.

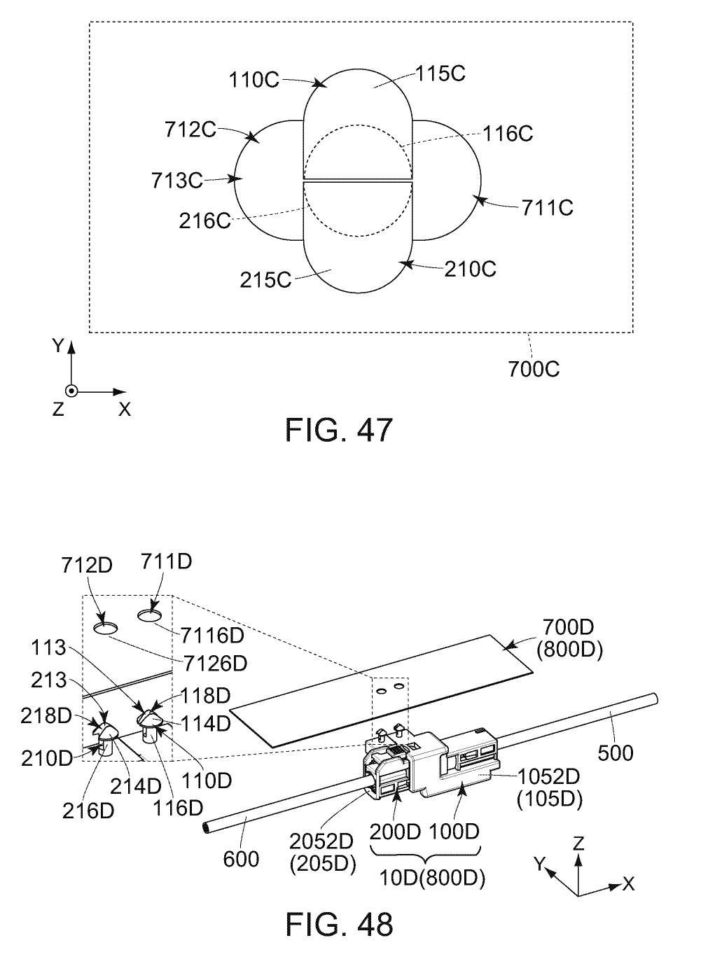

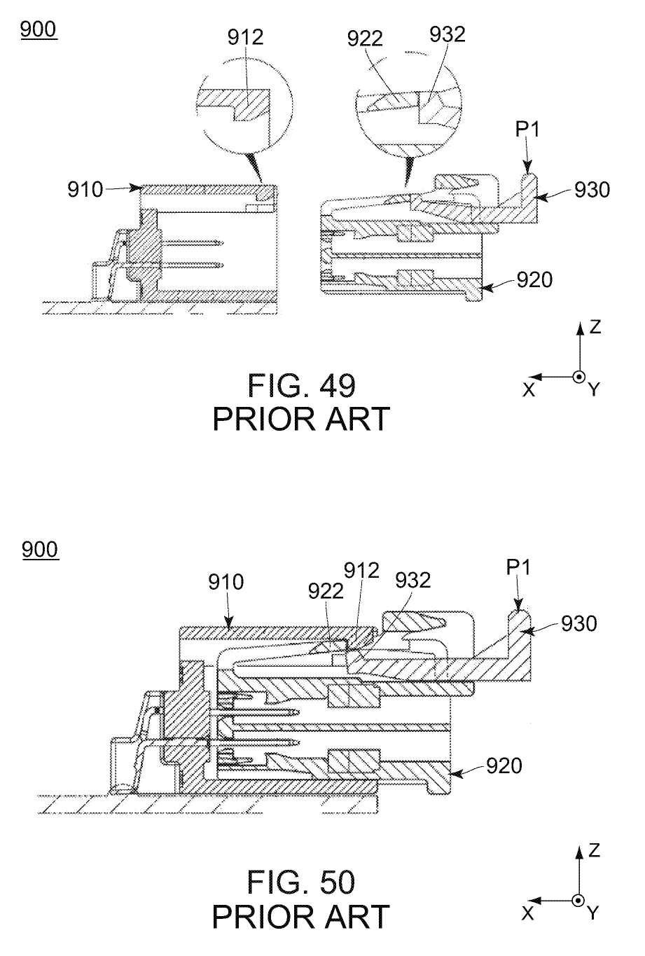

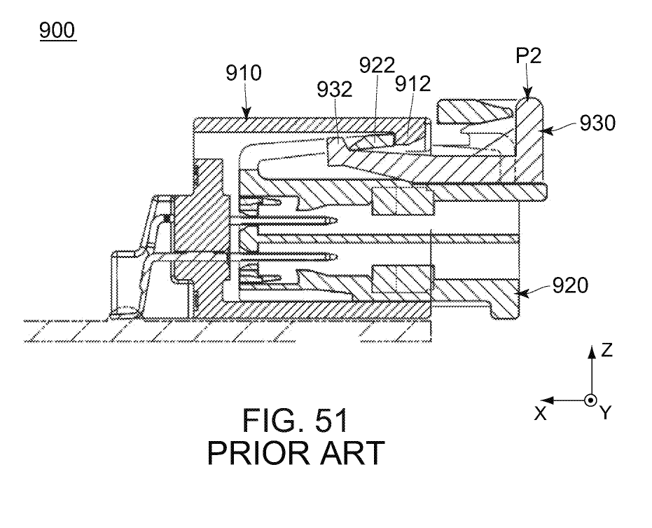

Referring to FIGS. 46 and 47, the structure of the present modification is configured so that, when the connector assembly in the completely mated state is attached to the case 700C, the first position-regulating portion 110C is received in the first position-regulated portion 711C while the second position-regulating portion 210C is received in the second position-regulated portion 712C.

As described above, the connector assembly of the present modification is configured as follows: the connector assembly is attachable to the case 700C in the completely mated state where the first connector and the second connector are completely mated with each other; and, when the connector assembly in the completely mated state is attached to the case 700C, the first position-regulating portion 110C is received in the first position-regulated portion 711C while the second position-regulating portion 210C is received in the second position-regulated portion 712C. Accordingly, the connector assembly of the present modification is also prevented from being attached to the case 700C in the middle-of-mating state where the first connector and the second connector are not completely mated with each other. In other words, the connector assembly of the present modification also more reliably assures the complete mating of the first connector with the second connector.

In the structure of the present modification, the connector assembly in the completely mated state is attached to the case 700C as follows. First, the connector assembly in the completely mated state approaches the case 700C in the predetermined direction. Then, the first extending portion 115C passes through the first position-regulated portion 711C and is moved to be located in the first orientation beyond the first position-regulated portion 711C, while the first supporting portion 116C of the first position-regulating portion 110C is received in the first position-regulated portion 711C. At this time, the second extending portion 215C passes through the second position-regulated portion 712C and is moved to be located in the first orientation beyond the second position-regulated portion 712C, while the second supporting portion 216C of the second position-regulating portion 210C is received in the second position-regulated portion 712C. Accordingly, the structure changes its state to a state shown in FIGS. 46. From this state, the connector assembly is rotated counterclockwise by 90° when the connector assembly is viewed from a location beyond the connector assembly in the first orientation. Then, each of the first extending portion 115C, the first supporting portion 116C, the second extending portion 215C and the second supporting portion 216C is rotated counterclockwise by 90°. Thus, the structure changes its state into a state shown in FIG. 47, and the attachment of the connector assembly to the case 700C is completed. In this state, an end portion of the first extending portion 115C in the second orientation is located in the first orientation beyond the first stopper portion 7116C as shown in FIG. 46, while the end portion faces the first stopper portion 7116C in the predetermined direction. Also, in this state, an end portion of the second extending portion 215C in the second orientation is located in the first orientation beyond the second stopper portion 7126C as shown in FIG. 46, while the end portion faces the second stopper portion 7126C in the predetermined direction. Accordingly, even if force in the second orientation is applied to the connector assembly of the present modification in the state of FIG. 47, the first extending portion 115C is engaged with the first stopper portion 7116C while the second extending portion 215C is engaged with the second stopper portion 7126C, and this prevents removal of the connector assembly from the case 700C.

The structure is configured as follows: if the connector assembly in the middle-of-mating state is intended to be attached to the case 700C, the receipt of the first position-regulating portion 110C in the first position-regulated portion 711C and the receipt of the second position-regulating portion 210C in the second position-regulated portion 712C cannot be performed simultaneously while the connector assembly maintains the middle-of-mating state.

### Third modification

Referring to FIG. 48, a structure 800D of a third modification comprises a case 700D and a connector assembly 10D. Specifically, the case 700D has a first position-regulated portion 711D and a second position-regulated portion 712D, and the connector assembly 10D is attachable to the case 700D along the predetermined direction.

As shown in FIG. 48, the first position-regulated portion 711D of the present modification pierces the case 700D in the predetermined direction. The first position-regulated portion 711D is a circular hole.

As shown in FIG. 48, the case 700D of the present modification has a first stopper portion 7116D.

As shown in FIG. 48, the first stopper portion 7116D of the present modification faces in the first orientation. The first stopper portion 7116D is perpendicular to the predetermined direction. The first stopper portion 7116D is located outward of the first position-regulated portion 711D in a direction perpendicular to the predetermined direction.

As shown in FIG. 48, the second position-regulated portion 712D of the present modification pierces the case 700D in the predetermined direction. The second position-regulated portion 712D is a circular hole. The second position-regulated portion 712D is located in the fourth orientation beyond the first position-regulated portion 711D. It is noted that the first position-regulated portion 711D and the second position-regulated portion 712D are not directly coupled with each other.

As shown in FIG. 48, the case 700D of the present modification has a second stopper portion 7126D.

As shown in FIG. 48, the second stopper portion 7126D of the present modification faces in the first orientation. The second stopper portion 7126D is perpendicular to the predetermined direction. The second stopper portion 7126D is located outward of the second position-regulated portion 712D in the direction perpendicular to the predetermined direction.

Referring to FIG. 48, the connector assembly 10D of the present modification comprises a first connector 100D and a second connector 200D which are mateable with each other. The connector assembly 10D is attachable to the case 700D in a completely mated state where the first connector 100D and the second connector 200D are completely mated with each other. More in detail, the connector assembly 10D is attachable to the case 700D only in the completely mated state where the first connector 100D and the second connector 200D are completely mated with each other. In other words, the structure 800D is configured so that the connector assembly 10D cannot be attached to the case 700D while the connector assembly 10D maintains a middle-of-mating state where the first connector 100D and the second connector 200D are not completely mated with each other. Similar to the first connector 100A of the aforementioned embodiment, the first connector 100D of the present modification is also an electrical connector. The first connector 100D is configured to be connected to a first cable 500. The first connector 100D of the present modification has a first position-regulating portion 110D.

Referring to FIG. 48, the first position-regulating portion 110D of the present modification is a protrusion which is able to be received in the first position-regulated portion 711D. When the connector assembly 10D in the completely mated state is attached to the case 700D, the first position-regulating portion 110D is received in the first position-regulated portion 711D. The first position-regulating portion 110D has a plurality of first hook portions 114D, a plurality of first supporting portions 116D and a first slit 118D.

Referring to FIG. 48, each of the first hook portions 114D of the present modification defines an end of the first connector 100D in the predetermined direction. Specifically, each of the first hook portions 114D defines the end of the first connector 100D in the first orientation of the predetermined direction. The first hook portions 114D extend from the first supporting portions 116D, respectively, outward in the direction perpendicular to the predetermined direction. The first hook portions 114D and the first slit 118D form a head portion 113.

Referring to FIG. 48, each of the first supporting portions 116D of the present modification extends in the predetermined direction. Each of the first supporting portions 116D is elastically deformable. The first hook portions 114D are elastically supported by the first supporting portions 116D, respectively. Accordingly, each of the first hook portions 114D is movable in a plane perpendicular to the predetermined direction. In the plane perpendicular to the predetermined direction, a size of the head portion 113 in a state where each of the first supporting portions 116D is not elastically deformed is greater than a size of the first position-regulated portion 711D. When the connector assembly 10D in the completely mated state is attached to the case 700D, each of the first supporting portions 116D is received in the first position-regulated portion 711D.

As shown in FIG. 48, the first slit 118D of the present modification is located between the first hook portions 114D which are adjacent to each other. The first slit 118D is located between the first supporting portions 116D which are adjacent to each other.

As shown in FIG. 48, the first connector 100D has a first housing 105D. The first housing 105D has a first body portion 1052D. The first housing 105D has a configuration similar to that of the aforementioned first housing 105A. Accordingly, a detailed explanation thereabout is omitted. The first supporting portion 116D couples the first hook portion 114D with the first body portion 1052D.

As shown in FIG. 48, similar to the first connector 100A of the aforementioned embodiment, the second connector 200D of the present modification is also an electrical connector. The second connector 200D is configured to be connected to a second cable 600. The second connector 200D is located beyond the first connector 100D in the fourth orientation of the perpendicular direction. The second connector 200D has a second position-regulating portion 210D.

Referring to FIG. 48, the second position-regulating portion 210D is a protrusion which is able to be received in the second position-regulated portion 712D. When the connector assembly 10D in the completely mated state is attached to the case 700D, the second position-regulating portion 210D is received in the second position-regulated portion 712D. The second position-regulating portion 210D has a plurality of second hook portions 214D, a plurality of second supporting portions 216D and a second slit 218D.

Referring to FIG. 48, each of the second hook portions 214D of the present modification defines an end of the second connector 200D in the predetermined direction. Specifically, each of the second hook portions 214D defines the end of the second connector 200D in the first orientation of the predetermined direction. The second hook portions 214D extend from the second supporting portions 216D, respectively, outward in the direction perpendicular to the predetermined direction. The second hook portions 214D and the second slit 218D form a head portion 213.

Referring to FIG. 48, each of the second supporting portions 216D of the present modification extends in the predetermined direction. Each of the second supporting portions 216D is elastically deformable. The second hook portions 214D are elastically supported by the second supporting portions 216D, respectively. Accordingly, each of the second hook portions 214D is movable in the plane perpendicular to the predetermined direction. In the plane perpendicular to the predetermined direction, a size of the head portion 213 in a state where each of the second supporting portions 216D is not elastically deformed is greater than a size of the second position-regulated portion 712D. When the connector assembly 10D in the completely mated state is attached to the case 700D, each of the second supporting portions 216D is received in the second position-regulated portion 712D.

As shown in FIG. 48, the second slit 218D of the present modification is located between the second hook portions 214D which are adjacent to each other. The second slit 218D is located between the second supporting portions 216D which are adjacent to each other.

As shown in FIG. 48, the second connector 200D has a second housing 205D. The second housing 205D has a second body portion 2052D. The second housing 205D has a configuration similar to that of the aforementioned second housing 205A. Accordingly, a detailed explanation thereabout is omitted. The second supporting portion 216D couples the second hook portion 214D with the second body portion 2052D.

As described above, the connector assembly 10D is configured as follows: the connector assembly 10D is attachable to the case 700D in the completely mated state where the first connector 100D and the second connector 200D are completely mated with each other; and, when the connector assembly 10D in the completely mated state is attached to the case 700D, the first position-regulating portion 110D is received in the first position-regulated portion 711D while the second position-regulating portion 210D is received in the second position-regulated portion 712D. Accordingly, the connector assembly 10D of the present modification is also prevented from being attached to the case 700D in the middle-of-mating state where the first connector 100D and the second connector 200D are not completely mated with each other. In other words, the connector assembly 10D of the present modification also more reliably assures the complete mating of the first connector 100D with the second connector 200D.

In the structure 800D of the present modification, the connector assembly 10D in the completely mated state is attached to the case 700D as follows. First, the connector assembly 10D in the completely mated state approaches the case 700D in the predetermined direction. Then, each of the first hook portions 114D abuts against a periphery of the first position-regulated portion 711D while each of the second hook portions 214D abuts against a periphery of the second position-regulated portion 712D. From this state, the connector assembly 10D further approaches the case 700D in the predetermined direction. Then, each of the first supporting portions 116D is elastically deformed so that the first hook portions 114D approach each other. At this time, each of the second supporting portions 216D is elastically deformed so that the second hook portions 214D approach each other. Accordingly, in the plane perpendicular to the predetermined direction, the size of the head portion 113 becomes equal or smaller than the size of the first position-regulated portion 711D while the size of the head portion 213 becomes equal or smaller than the size of the second position-regulated portion 712D. From this state, the connector assembly 10D still further approaches the case 700D in the predetermined direction. Then, each of the first hook portions 114D passes through the first position-regulated portion 711D and is moved to be located in the first orientation beyond the first position-regulated portion 711D. At this time, each of the second hook portions 214D passes through the second position-regulated portion 712D and is moved to be located in the first orientation beyond the second position-regulated portion 712D. Thus, each of the first supporting portions 116D of the first position-regulating portion 110D is received in the first position-regulated portion 711D while each of the first supporting portions 116D is restored to its original shape. At this time, each of the second supporting portions 216D of the second position-regulating portion 210D is received in the second position-regulated portion 712D while each of the second supporting portions 216D is restored to its original shape. In this state, an end portion of each of the first hook portions 114D in the second orientation is located in the first orientation beyond the first stopper portion 7116D, while the end portion faces the first stopper portion 7116D in the predetermined direction. Also, in this state, an end portion of each of the second hook portions 214D in the second orientation is located in the first orientation beyond the second stopper portion 7126D, while the end portion faces the second stopper portion 7126D in the predetermined direction. Accordingly, even if force in the second orientation is applied to the connector assembly 10D in this state, each of the first hook portions 114D is engaged with the first stopper portion 7116D while each of the second hook portions 214D is engaged with the second stopper portion 7126D, and this prevents removal of the connector assembly 10D from the case 700D.

The structure 800D is configured as follows: if the connector assembly 10D in the middle-of-mating state is intended to be attached to the case 700D, the receipt of the first position-regulating portion 110D in the first position-regulated portion 711D and the receipt of the second position-regulating portion 210D in the second position-regulated portion 712D cannot be performed simultaneously while the connector assembly 10D maintains the middle-of-mating state.

Although the specific explanation about the present invention is made above referring to the embodiment, the present invention is not limited thereto and is susceptible to various modifications and alternative forms.

Although the connector assemblies 10, 10A, 10D of the present embodiments and modification are configured so that the first connector 100, 100A, 100D is configured to be connected to the first cable 500 while the second connector 200, 200A, 200D is configured to be connected to the second cable 600, the present invention is not limited thereto. Specifically, the connector assemblies 10, 10A, 10D may be modified so that the first connector 100, 100A, 100D is configured to be connected to the first cable 500 while the second connector 200, 200A, 200D is configured to be mounted on a circuit board. Alternatively, the connector assemblies 10, 10A, 10D may be modified so that the first connector 100, 100A, 100D is configured to be mounted on a circuit board while the second connector 200, 200A, 200D is configured to be connected to the second cable 600. Further, the connector assembly 10, 10A, 10D is not limited to the electrical connector assembly, and the present invention is also applicable to any connector assembly 10, 10A, 10D such as an optical connector assembly, provided that the connector assembly 10, 10A, 10D in the middle-of-mating state, where the first connector 100, 100A, 100D and the second connector 200, 200A, 200D are not completely mated with each other, is prevented from being attached to the case 700, 700A, 700D.

While there has been described what is believed to be the preferred embodiment of the invention, those skilled in the art will recognize that other and further modifications may be made thereto without departing from the spirit of the invention, and it is intended to claim all such embodiments that fall within the true scope of the invention.

What is claimed is:

1. A connector assembly attachable to a case having a first position-regulated portion and a second position-regulated portion, wherein:
the connector assembly comprises a first connector and a second connector which are mateable with each other;
the first connector has a first position-regulating portion;
the second connector has a second position-regulating portion;
the connector assembly is attachable to the case in a completely mated state where the first connector and the second connector are completely mated with each other; and
when the connector assembly in the completely mated state is attached to the case, one of the first position-regulating portion and the first position-regulated portion receives a remaining one of the first position-regulating portion and the first position-regulated portion while one of the second position-regulating portion and the second position-regulated portion receives a remaining one of the second position-regulating portion and the second position-regulated portion.

2. The connector assembly as recited in claim 1, wherein:
the first position-regulating portion is a receiving portion which is able to receive the first position-regulated portion;
the second position-regulating portion is a receiving portion which is able to receive the second position-regulated portion; and
when the connector assembly in the completely mated state is attached to the case, the first position-regulating portion receives the first position-regulated portion while the second position-regulating portion receives the second position-regulated portion.

3. The connector assembly as recited in claim 1, wherein:
the first position-regulating portion is a protrusion which is able to be received in the first position-regulated portion;
the second position-regulating portion is a protrusion which is able to be received in the second position-regulated portion; and
when the connector assembly in the completely mated state is attached to the case, the first position-regulating portion is received in the first position-regulated portion while the second position-regulating portion is received in the second position-regulated portion.

4. The connector assembly as recited in claim 1, wherein:
the case is provided with a first engaged portion and a second engaged portion;
the first connector is provided with a first engaging portion;
the second connector is provided with a second engaging portion;
the connector assembly is configured to be attached to the case along a predetermined direction; and
when the connector assembly in the completely mated state is attached to the case, the first engaging portion and the first engaged portion face each other in the predetermined direction while the second engaging portion and the second engaged portion face each other in the predetermined direction, and thereby the connector assembly is prevented from being removed from the case.

5. The connector assembly as recited in claim 4, wherein:
the first connector has a first supporting portion;
the first supporting portion supports the first engaging portion and is elastically deformable;
the first engaging portion is movable in a direction intersecting with the predetermined direction;
the second connector has a second supporting portion;
the second supporting portion supports the second engaging portion and is elastically deformable; and
the second engaging portion is movable in a direction intersecting with the predetermined direction.

6. A structure comprising the case and the connector assembly as recited in claim 2, the case having an attached portion with a flat-plate shape, the connector assembly being attachable to the attached portion along a predetermined direction, wherein:
each of the first position-regulated portion and the second position-regulated portion is formed as a part of the attached portion;
the first position-regulated portion and the second position-regulated portion are located apart from each other in a perpendicular direction perpendicular to the predetermined direction;
each of the first position-regulating portion and the second position-regulating portion is a groove extending in a plane defined by the predetermined direction and the perpendicular direction; and
each of the first position-regulated portion and the second position-regulated portion is provided with a guide portion which is oblique to the predetermined direction.
